(19) United States
(12) Patent Application Publication
(10) Pub. No.: US 2013/0283232 A1
(43) Pub. Date: Oct. 24, 2013

(54) User-Friendly Method and System for Compiling a Unique Sample Code for a Digital Sample with the Help of a User Interface

(71) Applicant: Oedses Klaas Van Megchelen, Ede (NL)

(72) Inventor: Oedses Klaas Van Megchelen, Ede (NL)

(73) Assignee: VAN MEGCHELEN & TILANUS B.V., Ede (NL)

(21) Appl. No.: 13/989,640

(22) PCT Filed: Jun. 16, 2011
(86) PCT No.: PCT/NL11/50435

§ 371 Date: Jul. 12, 2013

(30) Foreign Application Priority Data
Nov. 24, 2010 (NL) PCT/NL2010/050786

(51) Int. Cl. G06F 9/45

(52) U.S. Cl. CPC G06F 8/41
USPC 717/106

(57) ABSTRACT

Method for providing a digital sample with a unique sample code. Computer-readable media with computer-executable instructions and compiled sample codes for accessing digital samples, including physical embodiment of codes such as bar codes or other visually perceptible, radio frequency identification (RFID) codes. System for compiling a unique sample code and systems for handling a user's request for gaining access to a digital sample provided with a sample code.

The invention relates to a method for compiling a world-wide unique sample code for a digital sample. The invention also relates to a method for providing a digital sample with such a unique sample code. The invention moreover relates to a computer-readable medium with computer-executable instructions which, when loaded onto a computer system, provide the computer system with the functionality of any of the aforementioned methods. The invention additionally relates to a sample code as compiled by the above method. The invention besides relates to a system for compiling a unique sample code using the above method.

‘Globalization’ is commonly used as a shorthand way of describing the spread and connectedness of production, communication, transactions, distribution, and (IC) technologies in social and economic networks/cultures across the world. That spread has involved the interlacing of economic, technological, social, and cultural activity. This globalization in the sense of connectivity in economic, social, and cultural life across the world, has been growing for centuries. However, many believe the current situation is of a fundamentally different order to what has gone before. The speed, complexity, intensity and volumes of communication and exchange, the complexity and size of the networks involved, and the sheer volume of trade, transaction, interaction and risk give what we now label as ‘globalization’ a peculiar force. One has described globalization as the intensification of world-wide social and economic relations which link distant localities in such a way that local happenings are shaped by events occurring many miles away and vice versa. This involves a change in the way we understand geography and experience localness. As well as offering opportunities for new business and value creation it brings with considerable risks linked, for example, to marketing, technological change, climate change and business control. Examples of those risks are the data explosion on the web and the increasing piracy and counterfeiting.

Globalization, thus, has powerful economic, political, cultural and social dimensions. Developments in the life sciences, and in digital technology and the like, have opened up vast, new possibilities for production, reach and exchange. Innovations like the Web/Internet have made it possible to access information and resources across the world—and to (pre and post)coordinate activities in real time. An important downside of the globalization however is the creation of diffuse markets in which it is becoming harder and harder to control product marketing, communication and demand and supply chain/network processes leading to a considerable increase of the uncontrollable number of legal and illegal copies available using peer-to-peer (P2P) technologies. An end-user piracy, which is different from commercial piracy, is much more difficult and costly to control. An auxiliary drawback of these P2P technologies is that Internet traffic has grown enormously and explosively. Projections indicate that the Internet traffic will greatly increase, leading to pressure on data traffic and storage and resulting in an increased bandwidth demand on the world's Internet networks (World Wide Web). Moreover, this Internet traffic and storage increase will require improved hardware, software and data facilities regardless of their context. Present electrical energy consumption of the Internet is already substantial and is expected to increase significantly in the coming years.

The non-prepublished international patent application PCT/NL2010/050303 discloses a pre-coordinative method and system facilitating tracking and tracing legitimate digital samples to protect owners and other parties involved in the product demand and supply chain against infringement of intellectual property rights and to protect the both owners and customer against fraudulent distribution by sharing of digital products. To this end, this international patent application discloses a method for compiling a unique sample code for a digital sample, comprising: i) defining at least one sample code template comprising multiple sample code segments to be used for building a sample code for a digital sample, said sample code segments at least comprising: a sample owner identifying code segment, and a sample identifying code segment; ii) specifying the content of the sample code segments to be used for building said sample code, wherein the sample owner identifying code segment is specified by an Internet address, in particular an IP address or (a part of) a domain name, of an owner of the digital sample, iii) stringing the specified sample code segments to form the sample code, iv) defining a digital path to a digital location via which access can be gained to the digital sample, and v) creating a cross-reference between the sample code generated during step iii) and the digital path defined during step iv) in case the sample code and the digital path are mutually distinctive. By labelling each world-wide unique digital sample with a world-wide unique sample code acting as world-wide unique identifier, comparable with a DNA profile or fingerprint of the sample, one specific digital sample can be traced and distinguished easily and unambiguously from another digital sample (including a duplicated sample), and thus each digital sample can be identified throughout over the world regardless of its context. This world-wide unique identification will be facilitated by the recognizable (identifiable) incorporation of the IP address and/or the domain name of a (present or prior) owner of the digital sample. Moreover, since the digital sample code is associated with a digital path to a digital location where the digital sample, and eventual further information (metadata) relating to said digital sample, is stored and can be traced/found, it will enable interoperability and it can be verified relatively easily whether the digital sample has been manipulated or is authentic. This will considerably facilitate assessment of the authenticity of the digital sample and will hence facilitate authorized and controlled handling and securing, as well as tracking and tracing of the digital sample. Commonly, the digital sample will not be moved once stored at the digital location. In case the digital sample would still be moved to another digital or physical location, the cross-reference between the sample code and the digital path will be correspondingly updated, so the sample code will be permanently up to date and give permanent access to the digital sample as far as admitted by the authorisations. Hence, dead links due to changes of the digital paths to digital locations where digital samples are stored can and will be eliminated in this manner.

An object of the invention is to improve the user-friendliness of the aforementioned method for compiling a unique sample code for a digital sample.

To this end an embodiment of the invention relates to a method for compiling a unique sample code for a digital sample, comprising: A) defining at least one sample code template comprising multiple sample code segments to be used for building a sample code for a digital sample, said sample code segments at least comprising: a sample owner identifying code segment, and a sample identifying code segment, B) specifying the content of at least one sample code segment to be used for building at least one sample code, wherein the sample owner identifying code segment is specified by an Internet address, in particular an IP address and/or a domain name, of an owner of the digital sample, C) visualizing at least one specified code segment as a virtual storage folder in a user interface, D) specifying the sample identifying code segment by creating a digital sample name of a digital sample in a selected virtual storage folder, E) stringing the specified sample code segments to form the sample code, F) defining a digital path to a (true) storage location via which access can be gained to the digital sample, and G) creating a cross-reference between the sample code generated during step E) and the digital path defined during step F) in case the sample code and the digital path are mutually distinctive. By visualizing one or multiple specified code segments as virtual storage folders to form a virtual storage location in an interactive graphical user interface a user can virtually store a digital sample with a chosen sample name at a desired virtual location, wherein the (visualized) virtual path including the sample name will be stringed during step E) to form and display at least a part of the world-wide unique sample code for that particular sample file. The digital path to the true storage location of the sample file will often deviate from the virtual path used to create the sample code, as a result of which both paths will be linked by cross-reference which is commonly stored in a table or other kind of database. The sample code therefore functions as link for redirecting a user from a virtual storage location to a true storage location, via the cross-reference directly and indirectly made to the physical storage location where the digital sample can be found. Hence, the sample code is cross-related to the true storage location. A virtual storage is understood here as a storage structure that appears to be an ordinary physical storage structure; this from the view point of a user as well as the operation system. The virtual storage can be realized e.g. as a virtual drive, or as a shell extension looking like a virtual file/folder system structure and behaving like a normal file browser, such as Microsoft Windows Explorer® or Total Commander®. The interactive graphical user interface used to display and handle one or multiple specified code segments will be familiar and accessible for a user to work with, and will therefore lead to a relatively user-friendly method to generate, and optionally store, authorize, distribute, handle, track, and trace, a sample code for a digital sample, wherein the user will determine the content of one or multiple code segments and/or will determine which code segments have to be stringed during step E) by virtually storing the digital sample at a code segment based virtual storage location. In fact, the user will see an (icono)graphical representation of a sample code representing and cross-related to the digital sample. In practice, as soon as a file is created and a virtual folder is selected or created for saving, the file is encoded according to said virtual folder's branch equivalent code template. The file is tagged by the generated code. The file can be shared on a UI by dragging and dropping and by copy and paste the file's image within the virtual file system's folders as well as by copying its image (which in fact represents its code) into a distribution tool like emailing. The virtual file structure and the enabled file handling are analogue to the visual representations of folders and files in a usual backend computer file manager and enabled handling, e.g. the representation of folders and files by Windows Explorer and its enabled file handling functions; this, concerning its presentation and functional behaviour. However, the internal processing is different. The 1:1 mapping between code templates and virtual file system structure enables a. o. that (mobile) users can administer and maintain the code template structure by administering and maintaining a virtual folder structure quite simple for the part of a code template that is mapped to the virtual folders. E.g. dragging and dropping a virtual folder from one branch to another effects the code template definition of the two involved branches; the specific code template, that is equivalent to the branch where the virtual folder is dragged away “looses” a segment; the code template, that is equivalent to the branch where the virtual folder is dropped “wins” a segment in the sequence according to the virtual folder sequence in the branch. This means, the two involved code templates are updated. Such an update of the code templates' syntax and semantics requires a re-encoding of all files that are encoded by the predecessors of the updated code templates. If a virtual folder is copied to another branch, the original code template stays untouched; the code template, that is equivalent to the branch where the virtual folder is pasted, has to be updated and all files have to be re-encoded according to the extended code template. Just adding, removing, and renaming a virtual folder to/from/of a branch is also equivalent to updating a code template; and, in each case that a code template is updated all the files have to be re-encoded. However, all the former codes of re-encoded files will be working unchanged, if submitted, using their technological function like a URL (part of the URI family); e.g. when inserted in the search window of a browser. The receiving code engine recognizes the old code and presents the old or actual version or all versions of the file to the user according to the file's legal owner policy and according to the authorization of the submitting user in relation to the encoded file. If submitted in a browser search window, the code of a file will use URL technology and locate the file; in general, the location is a virtual location. It can be the physical storage location, too. If the virtual and physical storage locations of a file differ, the virtual and the physical storage locations are cross referenced with each other. The cross reference is maintained. Thus, if a file is re-encoded (the virtual location changes), the new code is cross referenced with the physical storage location. If the physical storage location changes, the cross reference with the virtual location is updated.

A user can share all files with other members of the user groups where he is a member of, automatically. If a user encodes a file with a code template that belongs to one of the user groups he is a member of, all the other members see this file automatically and may handle it with the rights the group has with respect to the applied code template. As aforementioned, encoding a file is in the experience of the user nothing else than saving a newly created or opened existing file within a folder of the virtual file structure that is offered by the code engine for the given application. Encoding or re-encoding can also be done by placing a file, by drag and drop into one of those virtual folders as described above. If a user wants to share a file from his personal virtual file system he just moves it into the destination virtual folder. Moving a file from a shared virtual folder into a private virtual folder can be limited or excluded. If a file should be shared with other users, that have related to their roles access to code templates different from the file's original one, however the file shall not be moved from its original virtual folder (means: it doesn't get a different code), a shortcut of the file is placed into the destination virtual folder. The shortcut will be encoded according to the code template, which is equivalent to the branch of the destination virtual folder. The code engine saves the relationship between the shortcut of the file and the file itself. If the shortcut is accessed, the code engine knows the access path to the file. As a result, the original file is accessed with the access rights that the shortcut got automatically by encoding it with the code template equivalent to the placement within the virtual folder structure. If a file shall be shared with users, that have no access to the virtual file structure of the code engine application, the code of the file is distributed e.g. by email or by another messaging tool. The functionality to send the code of a file within or attached to an email or another messaging tool is integrated into the UI and available if a file is selected within its virtual folder structure. The message with the sample code can be sent encrypted or shortened; the code itself can be digital signed as well as the message. The sending user has to authorize the receiving user about the handling of the file. The sending user can also decide that the receiving user may access the file without authenticating himself or if he has to authenticate himself to get access to the file. In another embodiment of the invention, functionality is used for predefining the authentication for at least some of (external) users. Furthermore, the authorization of such (external) users can be predefined. If the receiving user is a user who has access to the virtual file system part according to the encoding of the file, the user is enabled access according to the known authentication and authorization. A user may temporarily have no access to the virtual file system of the code engine application for whatever reasons, but have to access a file e.g. via a web browser. In such a case, he has to receive or know the file's code to submit it in a web browser, meaning to apply the URL technology for the code. If a code is submitted to the code engine via a web browser, the receiving code engine evaluates if the received code is a valid one in the scope of the application, if the submitting user has to identify and authenticate himself; if so, if the identification and authentication data are right; and which access rights this user has with respect to the submitted code. The code engine enables access to the file according to the found access rights. The file is presented in the web browser, but accesses on its central location by default. Downloading of a digital sample can be allowed dependent on the access rights of the particular user with respect to the file.

The digital sample may comprise an item such as a digital document, a digital book, a digital contract, music file, video file, a game file, a web page file, web content, a digital graphical representation of data, an Internet index file, or any other digital item. After compiling the sample code and connecting the sample code to the digital sample, commonly by tagging the digital sample, the digital sample can be identified and accessed using said unique sample code that is compiled in accordance with embodiments of the invention. Thus, the code and use of the code in various embodiments described herein can be of help, for example, when one wants to correctly identify such a digital sample (such as document or file or other digital sample). The code, based on principles of at least partial pre-coordination, may also help to trace and assure authenticity of the digital sample, to restrict or provide access to the digital sample, to distribute the digital sample to selected recipients, to sell or otherwise monetize the digital sample or to otherwise help provide distribution of or access to the digital sample. As an example, a unique sample code may be provided for a music file. A user is provided permitted access to the music file unrestrictedly or for example for a restricted period of time, and the music file is identified, based on the sample code. Further, the sample code may be embedded into the music file to stream and to facilitate tracking and tracing of the music file.

A digital sample, also considered as a single individual digital entity, is thus defined to have a world-wide unique identity and to be distinguishable (individualizable) and hence trackable and traceable with certainty from a range of all other digital samples in the scope of its specification criteria. A digital sample as an individual entity therefore differs from a digital product series, a digital product category, or a digital product variety. In the context of the patent application the nature and representation of the term “digital sample” should be interpreted broadly and could include a digital file, a digital textual description, a digital image, a digital collection of multiple digital samples, a digital transaction, or a digital service. The term “owner” incorporates (among others) the originator, publisher, distributor, author, and creator provided that an actual or previous ownership of the digital sample can be deduced from the IP address and/or the domain name of the owner as used and visualized in the sample code itself. The term (true) “digital location” can be a location at a computer of the owner as code issuing party, though it can also be a remote location in a private or public cloud computing infrastructure employing Internet-based computing, whereby shared resources, software and information are provided to computers and other devices on-demand, like a public utility. The context independent sample codes may be stored in a computing cloud, while the digital samples are stored in a location separate from the computing cloud, which would reduce the traffic and storage load within the cloud and would also be beneficial for interoperability and security reasons.

Each unique digital file is marked with a world-wide unique sample code. This sample code may represent a file name of the digital sample and/or may be embedded in the digital sample. Sharing the digital sample may be realised by simply sharing the sample code as such, which will provide a lead to the location where the digital sample is stored. Since simply sharing the sample code (approximately 1 kilobyte, for example) will be sufficient to allow authorized sharing of the digital sample (commonly significantly larger than 1 kilobyte), exchanging the digital sample as such is no longer necessary, which can help lead to a significant reduction of the Internet traffic and moreover the (multiple) data storage lead which is advantageous from a financial, safety-related and environmental point of view. Sharing of the sample code can be realised e.g. via email, and/or via a (restricted) web based platform, such as a graphical community (multi-user) dashboard. In a preferred embodiment, the virtual storage folder makes part of a web based graphical dashboard. The multi-user dashboard can be a public (open) dashboard or a private (restricted) dashboard via which sample codes, and (optionally) information related to the sample code or co-related digital sample, can be published and thus shared. It is conceivable to provide users ((dashboard) members) restricted access, for example by providing permitted users password based access data, after which access to the dashboard is merely possible after authentication of the permitted user. In an embodiment user based activities related to the sample code and/or the digital sample are logged and can optionally be displayed in an activity stream. These activities may incorporate e.g. comments related to the digital sample and/or modifications of the digital sample and/or sample code. Preferably, at least a part of the logged user based activities is published on the graphical dashboard. It is further imaginable to log and publish/share digital sample related statistics (analytics), such as loyalty information like the frequency of visits per visitor, the time spent by visitors, and the visitor recency. Since the dashboard will commonly merely be used for publishing and hence sharing textual information, in particular the sample code and eventual further (textual) information, the size of dashboard information to be stored is rather limited, which is beneficiary from both an economic and environmental point of view. In a particular preferred embodiment the dashboard as such is considered as a digital sample and is provided with a user-recognizable unique sample code in line with the invention. By sharing this dashboard sample code other users can be provided access to the dashboard and hence to sample codes (related to digital samples) as published on said dashboard. Hence, the dashboard sample code represents a key to one or multiple further sample codes published on said dashboard.

In an embodiment of the method according to the invention the name or label of the virtual storage folder is related to the content of the specified code segment during step C). Hence, the content of the specified code segment can be directly recognized by the user using the user interface to store, search, and/or retrieve digital samples, which will further improve the accessibility and approachability of the user interface.

The sample owner identifying code segment is commonly (pre)specified by the owner, whereas the sample identifying code segment may be specified by a creator or user of the digital sample. It is conceivable that the sample identifying code segment is specified by the owner, wherein a user or file creator may determine e.g. the virtual folder in which the digital sample is virtually stored. Saving the digital sample in a virtual folder of the invention triggers generating the sample code automatically. The virtual folder path from the root (the owner definition) up to the saving virtual folder (including this folder) is the blueprint for the code generation. In case that the digital sample is a file, the file name plus its file format is applied as segment value for the last individual segment of the sample's code. Thus, all files virtually stored in a virtual folder of the invention get a similar code: the path segments are the same because they mirror the virtual folder path (a string of the names of the folders); the sample naming segment is different for each of the sample files. This supports displaying semantics similar digital samples within a describing logical virtual storage structure.

This method is possible because the structure and meaning of a code and its segments are following a predefinition that is called code template. The code templates are meta-codes that define the syntax of the code string for a given set of semantically similar samples. They define also the semantics of each segment. The semantics definition ca start on a very high abstract level and can be refined segment by segments by children of the semantically more abstract templates. The last child of a template hierarchy and a code differ semantically only in the value of the last segment. The child template's segment defines that the segment has to define e.g. the name of the digital sample file. The code inherits all the values of that child template segments (as well as the syntax), but overwrites the general template segment value for the naming segment with the name including file format of the file as digital sample. As aforementioned, the sample code is associated with a virtual folder path (in fact a 1:1 mapping in both directions). Because the templates are meta-codes, a template is also mapped 1:1 to the virtual folder path (also in both directions). This enables to use the virtual folder path where a sample is saved to as template for the code generation of the saved sample. Moreover, the user selects the semantics specification of the file with his selection of the virtual folder that he uses to save the file. Although the folder path and file name (sample name), shown graphically e.g. by icons, appear to indicate the exact storage location of the digital sample, this merely shows the virtual storage location, commonly in an organized manner, via which a user can be led to the cross-reference database leading the user to the true storage location and hence to the digital sample itself.

The method allows automatic encoding samples one by one but also encoding sets of files automatically.

Commonly the sample code template is defined such that the sample code comprises one or more code segments besides the sample owner identifying code segment and the sample identifying code segment. These additional code segments are commonly specified during step B) and visualised during step C), wherein each specified code segment is shown as separate folder in a folder structure during step C). In case a code segment is specified several times in a mutually distinctive manner, the related different virtual folders are commonly visualized in the same folder level. In case, however, different code segments are specified during step B), preferably each specified code segment is shown as separate folder in a multi-level folder tree structure during step C), wherein each subsequent code segment is visualised as sub level of a each preceding code segment. The order wherein code segments are stringed to form a sample code is commonly also defined in the sample code template. The visualization of the virtual folder structure including the encoded files (digital samples) as virtual content of the virtual folders is realized in one or several graphical presentations. It is noticed that the visualization of the encoded files only seem to be the file; in fact, merely the sample code is represented. The visualization according to the invention can be done in just one type of graphical user interface, e.g. the aforementioned file browser representation, but also in a commonly used end-user dashboard or an administrator user control user interface. Important is here that all different types of user interfaces using the sample code of the invention can exist beside each other, can be used by the same user beside each other and are automatically synchronized and map to the sample code structure in both directions; meaning, an update in a virtual file and folder, independent on which kind of user interface it is done, is mirrored immediately in the sample's code and the template hierarchy that is parent to the code and vice versa.

In an embodiment of the method according to the invention, the user can be allowed to manipulate at least a part of the virtual folder structure. Although security permissions may be set on manipulation of one or more particular virtual folders, which commonly restrict the freedom of manipulation of the virtual folder(s) for a user, permitted manipulation of one ore more virtual folders can be performed in various manners by a user. A user may e.g. change the name or label of a virtual folder resulting in an amended specification of the code segment related to said virtual folder. A user may be allowed move a virtual folder within the same folder level and/or may be allowed to move a virtual folder to another folder level. Alternatively, during step C) or D) a user may create and specify at least one virtual folder related to a code segment to be stringed during step E). Hence, dependent of the user permissions set, a user may be allowed to manipulate the virtual folder structure and hence the sample code segments to be used to form a sample code. It is also imaginable that users will be allowed to modify the structure and/or names of the virtual folders and/or the digital sample name, and to share a common user interface and digital samples virtually stored via said database. An exemplary embodiment of a collaborative user interface will be elucidated hereafter. Although the virtualisation of the code segments as virtual folder structure is a very efficient and effective manner to allow users to generate and work with sample codes for uniquely coding digital samples, it may be beneficiary not to visualise all code segments specified during step B). In an internal environment, such as a company network or other private computer network, it may be desired not to show certain specified code segments, such as an obvious static (constant) code segment, like the sample owner identifying code segment, in order to improve the overview of visualised specified code segments. Visualizing of obvious specified code segments which do not vary in time will commonly lead to undesired complication of the user interface, as a result of which these types of specified code segments may be omitted from visualisation in a private network environment. Although one or multiple specified code segments may not be visualised during step C) these specified code segments will nonetheless be present in the sample code formed during step E).). Even if some segments are suppressed from presentation in one of the applied visualisations, these segments could be presented in an additional visualization.

The sample code segments are selectively ordered to build an identifying path referring either directly or indirectly to a digital location, in particular a web location, where the digital sample can be found. The digital path will commonly be represented in the format of a Uniform Resource Locator (URL) which may (automatically) be provided with a prefix, such as http, https, ftp, ftps, mailto, file, by a web browser. This is enabled only for the reason to support functioning of a code as URL if inserted into a web browser as search query. The code is no URL, but is or can function as a URL in a particular situation as mentioned. In an embodiment of the invention, at least a part of the digital path is identical to the sample code, meaning that the sample code is incorporated in the digital path. In case the sample code and the digital path are substantially identical, creating a cross-reference in accordance with step G) may be omitted, although this omission is not preferred. In this respect, the term “substantially identical” is being used to show that there may be a minor differences between the sample code and the digital path which do not have any effect in practice. For example, although the digital path will commonly have a prefix, such as “http://”, such a prefix may not be present in the visualized sample code itself. However, since any web browser will automatically add a prefix in front of a web address not already having such a prefix, the sample code as such may easily be used as web address (digital path) leading to a web location (digital location) where the requested digital sample is stored. Preferably, a cross-reference is made between each sample code (virtual digital path) and the storage location (true digital path), even in case the sample code slightly differs from the storage location.

In an embodiment of the invention, the method includes step H) comprising storing the sample code, the digital path, and the cross-reference between the sample code and the digital path in a database. Storing the cross-reference between the sample code and the digital path will facilitate translating the sample code into a true digital path where the digital sample can be found. Moreover, storage of this data will facilitate updating the cross-references in case of a change of the digital path in order to prevent unlinking (dead linking) and hence not finding of the sample code with respect to the actual location where the digital sample is stored and can be traced and found.

The method optionally comprises step I) comprising converting the sample code generated during step C) into a machine-readable format. In case the sample code is printed or displayed on a screen, the sample code may be read, for example, by using an optical scanner. By applying optical character recognition, the scanned sample code will be converted into a set of characters identical to the sample string of the sample code, which can subsequently be entered either automatically or manually into a web browser. The machine-readable sample code may also be represented in a digital or physical encrypted iconographic format, such as a 2D/3D barcode and/or a RFID tag or in the technological representation of the (shortened) URL. It should be noted that while these iconographic representations look similar to conventional iconographic representations, the content, meaning, and use of the iconographic representation of the sample code is completely different from the conventional iconographic representation of known sample series and/or categories codes.

Alternatively, the method comprises step J) comprising translating at least the sample identifying code segment of the sample code into another language and matching characters. Since the sample identifying code segment preferably comprises metadata relating to the digital sample associated with the sample code, the metadata providing relevant recognizable information about the digital sample, it will be user-friendly to offer and display these metadata in the language of the location/country where the digital sample code is issued. An example of possible metadata incorporated and named in the at least one sample identifying code segment is information relating to the author, title, subject, keywords, size, version, date of creation, remarks, and/or status of the digital sample.

The IP address and/or the domain name of an owner as incorporated in the owner identifying code segment is commonly not translated and commonly remains unchanged during step J).

In an embodiment of the invention the sample code segments defined during step A) further comprise a user related code segment which may either be static or dynamic (dependent on one or more parameters which change in course of time). Although each sample code, irrespective of the presence of a user related code segment, already functions as a world-wide unique personal code, one advantage provided by incorporating a user related code segment is that the content stored at the digital location can be made more personal to the user. If agreed upon, personal information of the customer such as a client number, pseudonym and/or personal permissions (e.g., read/write permissions), can be displayed as content at the digital location and/or as metadata incorporated in the user related code segment. This user information may be static which therefore results in a static user related code segment. It is also imaginable that the user related segment incorporates user related information (metadata) which varies with the course of time, such as the age of the user or the user credits. Once issued, the sample code will not change, but the sample code issued may be dependent on parameters which are applicable at the moment of issuing the sample code. In practice, this would commonly require a last-minute compilation of the digital sample code after registration of relevant user data, such as name, address, et cetera. It is conceivable that the user related code segment comprises a user identifying code segment. In this manner, the identity, such as the name of the user, is evident from metadata represented by the code segments.

It is further imaginable that the sample code string comprises at least one intermediary identifying code segment relating to the identity of an intermediary e.g., used to manufacture, supply, support, distribute, sell, and/or promote the digital sample. The intermediary identifying code segment, optionally based on the domain name or IP address of the intermediary, may comprise the identity of the intermediary but may also comprise other metadata relating to the intermediary, such as a platform or service offered to the public via which digital samples can be accessed. One example is related to the distribution of music files via a music publishing service, such as Apple's iTunes, in which music files may originate from the company EMI Music Publishing. A sample code associated with a specific digital sample may be represented as follows: “www.emi.com/www.itunes.com/beatles-yesterday-12345”, wherein “www.emi.com” represents the owner identifying code segment, “iTunes.com” represents the intermediary identifying segment, and “beatles-yesterday-12345” represents the digital sample identifying segment including metadata relating to the artist, the title, and a unique identification number of the digital sample (which is the file name). Although the sample code may represented as a web link to a location where the specific music file is stored, the sample code will commonly be a cross-reference to another path leading to the specific music file.

It may be beneficial during step A) to define at least one punctuation mark for separating adjacent code segments during step C). A variety of punctuation marks can be used, though since the sample code often functions as URL, a slash (‘/’) sign may be used to separate adjacent code segments. In a correct URL syntax commonly a slash sign is also positioned behind the last code segment. In addition to these separation characters, other typographic signs, such as a tilde (‘˜’), a dot (‘.’), an underscore (‘_’), and a minus sign (‘−’), may also be used within the code segments themselves and/or between the code segments.

In an embodiment of the invention, the sample code string comprises at least one checking code segment representing the result of a predetermined mathematical processing of at least one other sample code segment. The algorithm used to calculate the value of the checking code segment will be defined when defining the sample code structure during compilation of the sample code. This algorithm may for example use or have similarities with the known category coding system ISBN (International Standard Book Number) code check. The algorithm for generating an ISBN check characters works as follows. To generate the ISBN check character, each ISBN digit is multiplied by a predetermined associated weighting factor and the resulting products are added together. The weighting factors for the first nine digits begin with 10 and form the descending series 10, 9, 8 . . . 2. Thus for the nine digits 0 9 4 0 0 1 6 3 3, the products summed are 0+81+32+0+0+5+24+9+6=157. This sum is divided by the number 11. (157/11=14 with 3 remainder). The remainder, if any, is subtracted from 11 to get the check digit. (11−3=8). If the check digit is 10, it is represented by the Roman numeral X. The final ISBN in this example is accordingly 0-940016-33-8. By generating the check digit and comparing it with the received check digit, the validity of the ISBN may be verified. As mentioned above, a similar or comparable check may be incorporated in the sample code especially when sample code representation formats like barcodes are sensitive for damages.

In another embodiment of the invention the sample code segments defined during step A) further comprises a sample code security identifying code segment. Application of this code segment will counteract abuse of the sample code by parties with malicious intent, since this security identifying code segment will be used as check to determine the authenticity of the sample code. For example, after entering the sample code into a web browser, a validity check of the sample code security identifying code segment may be performed. This security related code segment may be time-dependent (“dynamic”), meaning that the code segment will only be valid for a limited period of time. In case the security check shows that the sample code is no longer valid or in force, access to the digital sample will not be granted. The security identifying code segment hence acts as an interactive key to gain access to the digital sample file.

During step A) not only the number and kind of the code segments used to build a code may be defined, but also the order of defined code segments to be stringed may also be defined. This allows for creation of a complete sample code template (code format), wherein code segments are ordered in a predetermined order. Determining the order of code segments during step A) can enhance the handling of sample codes and co-related storage locations of the digital samples.

In an embodiment of the invention, step A) may be repeatedly performed to generate multiple sample code templates, wherein the method further comprises step K) comprising choosing a code template to be applied prior to executing step B). Generating multiple templates may allow for additional differentiation in sample codes provided to users. For example, a party may offer digital samples directly to customers and indirectly to customers by making use of an intermediary. In doing so, different sample code templates may be used, where the direct customers may receive a code such as “www.owner.com/sample_id_{—}1234” which does not use an intermediary, while indirect customers may receive a code such as “www.owner.com/www.intermediary.com/sample_id_{—}5678” which utilizes an intermediary.

The aforementioned method may be performed using a software module generating the interactive user interface to allow the user to generate a world-wide unique sample code.

An embodiment of the invention also relates to a method for providing a digital sample with a unique sample code, comprising: L) creating a digital sample, M) compiling a unique sample code for the digital sample according to the method described above, N) marking the digital sample with at least one compiled sample code, O) storing the digital sample at a digital location, P) storing the sample code, and Q) creating a cross-reference between a digital path referring to said digital location and the sample code in case the sample code and the URL are mutually distinctive. Marking the sample with the digital sample code according to step N) may facilitate tracking and tracing of the digital sample in case the digital sample is downloaded from a secure environment such as a web server owned or operated by the owner. In case of streaming of the content of the digital sample, e.g., in case the digital sample is a music file or a video file, a user may not be able to download the specific sample, which may result in to an improved distribution control of the digital sample. A digital sample may be labelled with multiple unique sample codes. The multiple unique sample codes may be embedded in the digital sample and will not be recognized by a standard user. For example, embedding multiple sample codes into one digital sample could be advantageous if the digital sample is a multimedia file which is distributed to multiple users, with each user having his own unique sample code to access the digital sample.

In an embodiment of the invention, the method may include step R) comprising providing the sample code to a user, for example the creator of the digital sample. This may be performed by sending the user an e-mail which includes the sample code. The sample code may be displayed as plain text in the body of the email which contains a hyperlink. Alternatively, the sample code may be attached as a separate attachment to the email. Since the sample code is commonly represented by a string of a limited number of alphanumeric signs and punctuation marks, the sample code is commonly no larger than 1 kilobyte. Since only the sample code and not the digital sample is distributed, Internet traffic and storage load may be significantly reduced. By storing sample codes instead of the sample files in a computing cloud, users can be offered a secure exchange of information in cloud computing environment.

It is conceivable and commonly preferable that the sample code is embedded as metadata into the digital sample forming a tag, mark, or label of the digital sample, which facilitates tracking and tracing of the digital sample. The embedded sample code may be kept either visible or invisible (code inside the sample) for standard users. An embodiment of the invention comprises a digital sample that has a sample code according to any of the embodiments described herein.

An embodiment of the invention moreover relates to a computer-readable medium with computer-executable instructions which, when loaded onto a computer system, provide the computer system with the functionality of the method for compiling a sample code, and/or the method of providing a sample code to a digital sample as described above. Examples of computer-readable media are USB-sticks, internal and external hard drives, diskettes, CD-ROM's, DVD-ROM's, and others.

An embodiment of the invention additionally relates to a sample code as compiled by the above method. Advantages of the use of a world-wide unique sample code acting as a “fingerprint” have already been described herein.

An embodiment of the invention further relates to a system for compiling a world-wide unique sample code using the above method, comprising: at least one sample code template generator for defining at least one sample code template comprising multiple sample code segments to be used for building a sample code for a digital sample, said sample code segments at least comprising a sample owner identifying code segment, and a sample identifying code segment, at least one sample code segment specification module connected to said template generator for specifying the content of at least one sample code segment defined by means of the code template generator, wherein the sample owner identifying code segment is specified by an Internet address, in particular an IP address and/or a domain name, of an owner of the digital sample, at least one visualization module connected to said specification module for visualizing at least one specified code segment as virtual storage folder in an interactive user interface, at least one data entry module connected to said visualization module allowing the user to specify at least the sample identifying code segment by creating a digital sample name of a digital sample in a selected virtual storage folder, at least one code generator connected to said template generator and said specification module for stringing the specified sample code segments to form the sample code, and at least one database for storing at least one cross-reference between a generated sample code and a digital path to a digital location via which access can be gained to the digital sample in case the sample code and the digital path are mutually distinctive. For example, some embodiments of the sample code have already described herein.

In some embodiments of the invention, the system may be a (cloud) computer-implemented system which may be fully automated after proper setup and initialization. An embodiment of the system may further include at least one service module for administering the system for issuing a sample code. A digital user/administrator interface for controlling and maintaining the template generator, the specification module, and the code generator are included in the system according to an embodiment of the invention. The system may additionally include a sample storage device for storage of a digital sample at a digital location of which the digital path is stored in the database. An example of a suitable sample storage device is a web server, optionally in the cloud. In an embodiment of the invention, the system further includes a distribution/communication module for distributing/communicating the generated sample code to one of more users.

A code system employed in embodiments of the invention may not be context sensitive and may thus be applied in a wide range of different areas, including, but not limited to electronic samples, physical samples, services, and rights. For example, mail carriers may use a package tracking system that allows for tracking of a package during its delivery. However, their tracking system only works in the context of their particular tracking environment, and cannot be used, for instance, to track items outside of that environment. Embodiments of the invention allow for a context-independent, broad or worldwide identification of specific samples based on metadata particular to each individual sample. If desired, the code system described in embodiments of the invention could be used in a specific internal scope by including an internal reference to the origin or scope of the sample inaccessible to outside users. In addition, a purely internal specification scope of the code system used by a specific company could be transformed into an external scope accessible to other organizations or individuals by integrating the origin or source of the sample into the specification scope. A scope change to transforming an external specification scope of the code system to an internal scope could also be similarly performed by removing a reference to the origin or scope of the sample. Furthermore, a code system according to an embodiment could be configured to allow for access to a variety of samples of different types. The other organizations or individuals may be provided access on a selected basis according to various embodiments, for example, with different levels of permissions, different groups and subgroups, different security levels, and so forth.

Some embodiments of the invention pertain to the use of code generators for a variety of purposes, including, but not limited to the generation of values for a particular code segment, defining sample code templates used for building sample codes for a digital sample, or combining various sample code segments together to form a sample code. For example, a code generator may generate the specified segment values by executing its function using input values from a variety of data sources, including, but not limited to, queries on a database or metadata input from the digital sample. Code generators may be used for quality or integrity control segments, and also for segments with a dynamic value.

Some embodiments of the invention also allow for the controlled use of metadata solely on an authorization basis of the user. For example, code samples may include a segment identifying the ownership or source of the digital sample, which may be accompanied by user specification segments identifying the user of the code sample in more detail. For example, the user specification segment could consist of an intermediate such as a distributor or retailer, a customer, consumer, controller, customs, or could be use definitions such as a patient, practitioner, pharmacist, inhabitant, or other. Such a user segment could specify that special meta data concerning the sample could only be accessed by the authorized user of the sample code, requiring that user to authorize or grant specific access to that sample.

Some embodiments of the invention also allow for partial sharing of sample code segment values by several codes if the coded samples share a portion of their specification metadata for identification. This could enable the owner or user of the sample codes additional error-checking or verification options in determining if the code samples are valid, or could enable the owner or creator additional processing options based on the shared metadata.

Some embodiments of the invention allow for the combination of sample codes for several samples to identify a new sample based on an existing relationship between the combined samples. For example, the combination of the samples can preserve the origin of the samples as well as any specification criteria related to the intermediaries of the combined samples.

The following are drawings illustrating non-limiting embodiments of the invention, wherein:

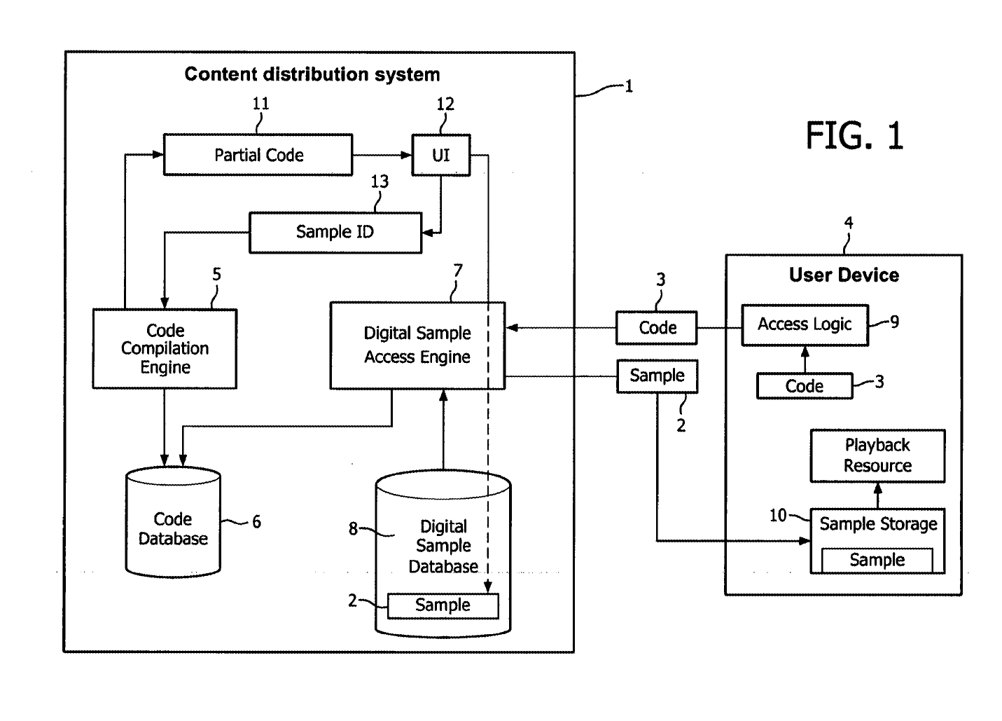

FIG. 1 shows a block diagram of a content reference system and a user device according to an embodiment of the invention,

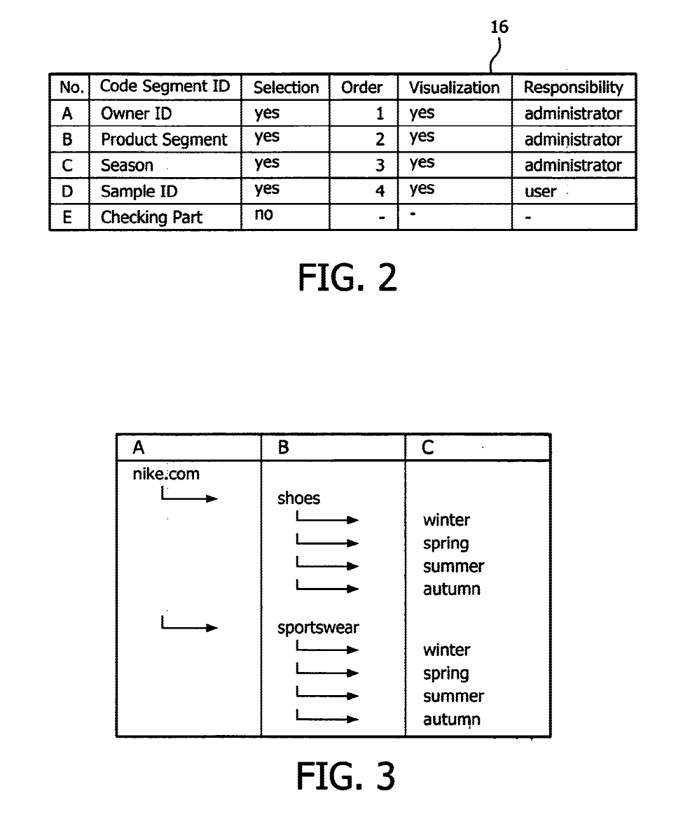

FIG. 2 shows a schematic view of a method for compiling a sample code according to an embodiment of the invention,

FIG. 3 shows virtual folder storage structure following the method related to FIG. 2,

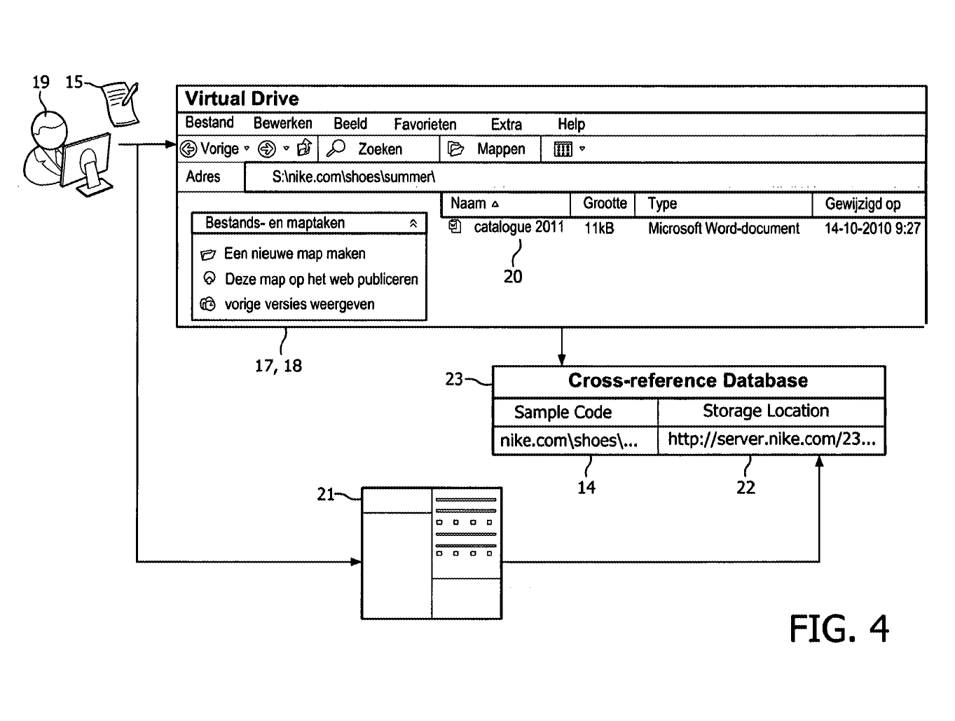

FIG. 4 shows a schematic view of a user storing a file and compiling a sample code for said file by using the method related to FIGS. 2 and 3,

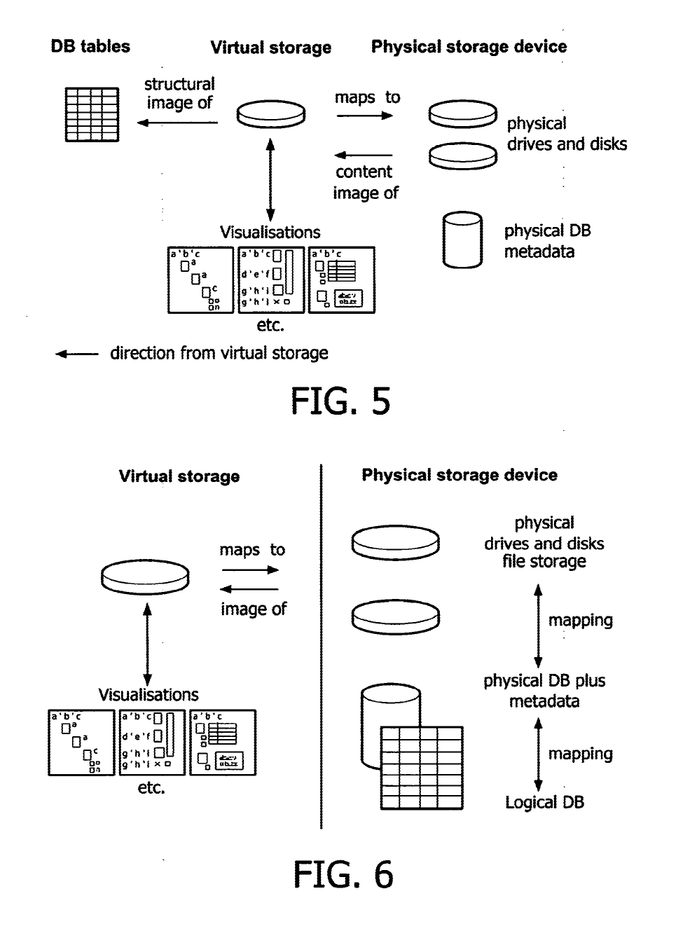

FIGS. 5-14 show schematic views of further embodiments of a method for compiling a sample code for a digital sample wherein use is made of an interactive user interface, and

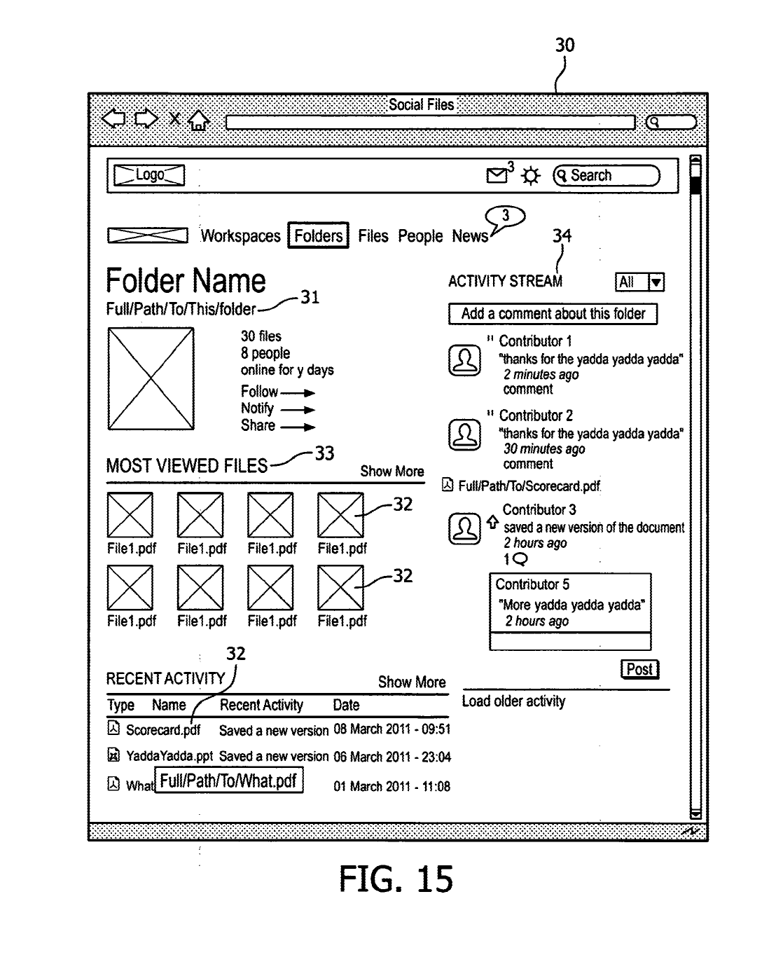

FIGS. 15-18 show views of different screens of an exemplary web based multi-user dashboard.

FIG. 1 shows a content distribution system 1 using digital samples 2 and unique sample codes 3 for the digital samples 2 according to an embodiment of the invention. The system 1 stores digital samples and makes the digital samples 2 available for access from and distribution to user devices 4. The system 1 compiles and displays digital sample codes 3 that identify and regulate (authorized) access to the digital samples 2. The digital samples 2 may be various items of digital content, such as documents, music files, video and other content, according to various embodiments. The exemplary content distribution system 1 includes at least a code compilation engine 5, a code database 6, a digital sample access engine 7, a digital sample database 8, a at least one administrator interface visualizing the sample codes, the code templates, co-related metadata, and settings. The content distribution system 1 may further include various computer and electronic resources such as processors, memory devices, various chipsets, interfaces, communication code and circuitry and network code and circuitry. The code compilation engine 5 compiles sample codes, by which digital samples can be accessed, and stores the sample codes in the code database. Sample codes are stored in the code database 6. The compilation may be done with the use of templates of code as described in more detail elsewhere herein. The digital sample access engine 7 provides access to the digital samples stored in the digital sample database 8. The digital sample access engine 7 provides the access based on the code corresponding to the respective digital samples 2. The user device 4 may be a mobile user terminal and may comprise a mobile telephone, mobile computer, personal computer or other user device. The user device 4 has code and/or circuitry to access digital samples 2 using the codes 3 corresponding to the respective digital samples 2. Additionally, the user device 4 has a mechanism that delivers least part of digital content items to a user of the user device 4. This the mechanism may comprise, for example, a display and an audio device. The code and/or circuitry to access the digital samples 2 using the codes 3 is shown as access logic 9. This logic 9 provides access to the digital sample 2 using the respective code in cooperation with the digital sample access engine 7 in the content distribution system 1. The user device 4 provides the code to the content distribution system 1, and in response, the content distribution system 1 delivers the corresponding digital sample 2. The user device 4 can then deliver least part of the digital content items to a user of the user device 4, for example, by displaying a document on a screen, by playing an audio file on a speaker, or by playing a video using a screen and speaker. Different user devices 4 associated with a user may also be used to access a unique sample code 2. For example, a sample code 2 may be sent to a user's email address, which is first accessed using a user device 4 such as a mobile computer. The same sample code 3 may be subsequently accessed by using a different user device 4 such as a mobile telephone. Thus, while the sample code 3 may be sent to an initial user device, the code may also be sent to a specified user who may enter the sample code into a variety of user devices 4. In addition, depending on the permissions granted to the user, the user may be able to share the sample code 3 with other users, for example by having the system 1 transmit the sample code to other user devices 4, enabling the other users to access the sample code 3 on their own user devices 4. The digital sample 2 may be stored in a sample storage 10 of the user device 4. In case a new digital sample 2 is stored or has to be stored in the digital sample database 8, the code compilation engine 5 will apply a predefined code template allowing specification of one or more code segments used by means of which a ‘partial code’ 11 could be formed. Said partial code 11 is visualized as a virtual storage folder structure in a interactive user interface 12. The user interface 12 is commonly launched on a terminal which may be a mobile terminal, such as a Smartphone, which is commonly provided with a keyboard and/or touch screen. The user interface 12 provides the user a well-organized of code segments, presented as virtual folders, used to compile a sample code. By allowing the user to assign a sample name or sample label (“sample ID”) 13 to the sample 2 stored or to be stored, as final code segment to complete to sample code 3, the code compilation engine 5 will be able to string all code segments including the sample ID 13 to form the sample code 3 which is subsequently stored in the code database 6. Embodiments of compiling a sample code 3 are described in the non-prepublished international patent application PCT/NL2010/050303, which document is incorporated herein by reference.

FIG. 2 shows a schematic view of a method for compiling a sample code 14 (see FIG. 4) according to an embodiment of the invention. This method will commonly be executed by a code (compilation) engine. In this exemplary embodiment, the sample code 14 is associated with a digital sample file 15 (see FIG. 4). By using the sample code 14, the digital file 15 can be tagged, tracked and traced, and a user may be able to gain access to the file 15. Hence, the sample code 14 may function as a “key” to obtain access to the file 15. According to an embodiment, the sample code 14 is embedded into the file 15 in order to facilitate tracking and tracing of the file 15 once downloaded. Compiling of the sample code 14 is described next. In a first step a code template 16 is defined, wherein different code segments are defined and selected for building the sample code (see column “Code Segment ID”). In a specific embodiment, the code segments “Owner ID” and “Sample ID” are compulsory, and other code segments are optional. The necessary code segments are used to make the origin of the file 15 (defined in the “Owner ID” code segment) and the relevant metadata, in this example the “Sample ID” segment related to the file 15, are directly recognizable to a reader or user of the sample code 14. The “Product Segment” and “Season” code segments are used to introduce further differentiation within the sample code which will be recognized as additional information by a user. The values will be used to create children templates of (mother) template 16. A “Checking Part” code segment relating to a check digit is used to control the accuracy or reliability of the file 15. The order of the selected code segments may then be determined. Commonly a slash or other type of separation is used to separate adjacent code segments. The selected and ordered code segments separated by a separation mark, will collectively form the code template 16 and derivate templates (children templates). It is further indicated which code segments have to visualised in a interactive user interface 17 and which code segments will not be displayed in the user interface. Finally, it is defined who will be the responsible person to specify the selected code segments. As can be seen in the scheme shown in FIG. 2 most code segments are to be specified by an administrator and one code segment has to be specified by a user. The code segments specified by the administrator are the code segments: “Owner ID”, “Product Segment”, and “Season”. In FIG. 3 an example of such a administrator specification is shown, wherein the administrator has defined the “Owner ID” as “nike.com” referring to the domain name of the owner of the file 15 to be coded. The code segment “Product Segment” has been given the values “shoes” and “sportswear”, en the code segment “Season” has been given the values “winter”, “spring”, “summer”, and “autumn”. Based upon the values given to the code segments recombination of values of different code segments can be made which are shown as tree structure in the scheme as shown in FIG. 3. The tree structure shown in FIG. 3 can be used to visualize a corresponding folder structure in a file browser 18 of PC or (other) mobile terminal of a user 19. The folder structure will then have the appearance of a virtual drive 20 for storing the file 15. Since the virtual drive can be visualised, for example, in Microsoft Windows Explorer® the user will directly be familiar with the visualised virtual structure. The user 19 can select a virtual folder for virtually storing the file 15, wherein the user 19 will provide the file 15 a filename 20, which filename 20 is visualised in the browser 18. The virtual path together with the filename 20 will be stringed according to the sample code template and will form the sample code 14 for the specific file 15, which is in this example: “nike.com/shoes/summer/catalogue_{—}2011”. Since the file 15 will physically be stored at another storage location on a server 21, a digital path 22 (http://server.nike.com/2343452543352/catalogue_{—}2011.doc) leading to said storage location is stored as cross-reference in a database 23. A method for gaining access to the file 15 by using the sample code 14 is disclosed in the non-prepublished international patent application PCT/NL2010/050303.

In the following further non-limitative embodiments of the method according to the invention are elaborated in textual and graphical manner.

A virtual storage is applied as an intermediary between a logical data structure and the storage on a physical storage device. The virtual storage has to mirror at least a part of the logical data structure as images of directories and files at one hand. At the other hand, it has to access the physical storage device or devices respectively that store the physical content of the files. This conceptual principle is illustrated in FIG. 5, abstracted from communication- and functional details, wherein the principle of mapping logical data structures to a virtual storage. If the mapping between the logical data structure and the physical storage as well as the mapping between those structures and the virtual storage is hidden from the user, the virtual storage seems to map to the physical storage as to be expected from the point of view of a user of the virtual storage; and, the virtual storage is an image of data from the physical storage, also as to be expected from the viewpoint of the same user. FIG. 6 illustrates this principle of mapping logical data structures to a virtual storage structure hiding DB layers

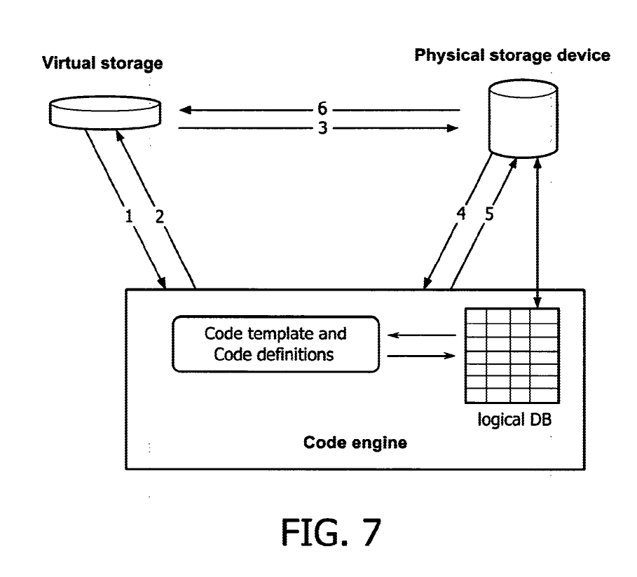

The next figure, FIG. 7 shows an embodiment of the communication between the virtual storage structure, the physical storage device and the logical data structure and an application that works on these logical data structures. FIG. 7 considers an embodiment of the communication between the participating sub-systems:

1. Request the structure/metadata/a fileOperation

2. Return the structure/metadata/transactionID

3. Request a file using transactionID

4. Request transaction verification and source location

5. Return true|false and the source location if applicable

6. Return the file or an error

The next part of this description explains an embodiment of the principles as illustrated in FIG. 7. Communication 3 until 6 is only realized when a user saves or opens a document or file respectively. The virtual storage device will never have any knowledge of the physical file location and storage method since that is masked in an embodiment of the invention by the storage web service and the use of a transactionID, see communication number 2 above. The interface between the virtual storage and the code engine consists of different parts, each with its own requirements. Those parts are:
a part that deals with the structure of the virtual file system,
a part that is dedicated to metadata of files (in an embodiment: documents) and directories
and a smaller part that processes fileOperations like Save and Open.

In an embodiment, the code engine's web service is responsible for creating an parse-able structure based on code templates and codes according to non-prepublished international patent application PCT/NL2010/050303. It is capable of returning a full structure of folder (directory) branches and included files (file system) a user has access to and also a partial structure which allows fast and nearly real-time updates to be communicated back and forth. An embodiment of the invention is here that these structures are requested from the virtual storage application (Pull); Push methods from the server to the virtual storage are another embodiment.

In an embodiment of the invention, the interface between the virtual storage and the storage web service is quite straight forward. The virtual storage either requests a file using a code engine generated transactionID, or tries to submit a file towards the storage, again using a code engine generated transactionID. The storage then retrieves or stores the file; the location of that storage is received from the code engine.

Suppose, the values of attribute CodeSegmentTemplate.Description of the code engine database have the values D4, D5, D6, and D7; the folder (directory) path of virtual drive D: would look like D:\D4\D5\D6\D7 at least in Windows XP. The table has also an attribute that defines the sequence of the segments.

The last code template segment is not mirrored into a folder. This template segment defines the code segment that gets a unique individual value per sample in all codes based on the code template T. In the example, one segment is chosen as defining the sample's individual identification value (like a single value primary key in a relational database table); however, these characteristics can also be fulfilled by several segments together (like a composed primary key in a relational database table). If the latter is the case, all those segments are not mirrored into a folder. Reason: their values are parts of the sample's individual identifier, e.g. parts of a file name.

The end-user sees the virtual folder system structure as usual e.g. in a file browser as soon as he accesses virtual drive D:.

The user is enabled to apply actions on the folder system structure itself and/or on files contained in these directories dependent on his authorization. Dependent on the security policy of the owner, the user sees
(a) only folders (directories) and files which he may access, at least for reading.
(b) all existing folders(directories) and files in the scope of his working area and his personal ones. However, he can get access only to these ones he is authorized for.

A storage device like a DB contains the data to which code templates and/or additionally to which particular codes a user has access with which kind of authorization.

### Encoding in Relationship to the Folder System Structure

Suppose the following code template examples:
Template T:
host.domainnames1.domainnamet1/segment4/segment5/segment6/segment7/segment8
Template T1 (child of T):
www.greenflower.com/D4/D5/D6/D7/documents
Code generated using T1:
www.greenflower.com/D4/D5/D6/D7/doc1.docx
Mapped virtual file system structure on virtual drive D:
D:\D4\D5\D6\D7
File with document doc1.docx placed in virtual directory D7; Institution internal path to doc1.docx:
D:\D4\D5\D6\D7\doc1.docx

Suppose that the last code segment template (number 8) of the example template T is of a segment type that expects a unique individual value on sample level for a document. This is supposed to be fulfilled by the document's name, followed by a dot, and the document type extension; example “doc1.docx”. The document is placed as file into the folder that mirrors the segment template 7 in the example; this is the last segment of a segment type not defining the samples unique individuality. Because document doc1.docx is a sample that is identified world-wide uniquely by a code following code template T, it gets encoded by applying code template T. The document's code mirrors also the—in the virtual file system structure hidden—part of the owner segments, the folder path describing values of segments 4 until 7, and the value of the 8^{th} segment, the name of the document. Suppose that segments 1 until 3 have the following values that are represented as a part of a code string “www.greenflower.com”, the code for document doc1.docx looks like “www.greenflower.com/D4/D5/D6/D7/doc1.docx”. In a real situation, the names D4, D5, D6, D7, and doc1.docs are meaningful names that specify and identify the document in the scope of its owner; the owner is here represented by “www.greenflower.com”.

“D4” until “D7” are names that are shared by all documents that are named in Segment 8. We call the child template with defined values for D4 until D7 “T1”; it is derived from template T by inserting real values for each path segment D4 until D7. See FIG. 4 for clarification by means of another example. This example code template is “www.greenflower.com/GFE/task1/document”. All documents of the institution with domain name www.greenflower.com that belong to the project with name “GFE” and “task 1” of this project share the same segment values “GFE” and “task1”. All documents belonging to task 2 of the same project share the segments with the names “GFE” and “task2”. All documents belonging to task 1 or task 2 of project GFE share the segment “GFE”; this beside the overall common segments “www”, “greenflower”, and “com”. As aforementioned, the segments D4 until D7 are mirrored into a branch of the virtual file system structure. Those segments have each the same value in the template T1 and in the derived code for the segments before segment 8.

“D4” until “D7” are not just folder names; the names originate in the metadata of a template that enables world-wide unique specifying and identifying of samples; always related to the identification of their owner e.g. by means of the owner's IP-address or the human readable representation as DNS. The virtual storage structure mirrors the code template structure always. Moreover, the virtual file system structure can be used to create code templates. By inserting a new virtual folder into a branch of directories or by appending a folder to a branch, a new segment of a code template is created, in fact. Code template hierarchy definition and encoding by applying code templates to samples are realized by applying the code engine of non-prepublished international patent application PCT/NL2010/050303.

### Distribution of Codes and Mapping of Distributed Codes to the Virtual Storage

The codes, created by the coding engine can be distributed e.g. by email or sms to users, which have no access to the virtual storage at first hand, instead of distributing the document as sample or the documents about the sample. The receiver of a code can e.g. put the code into a web browser and exploit so the code's characteristics to function as a resource locator in a web environment or in an institution internal network (intranet etc). The received code will be interpreted by the code engine.

The effect of applying a code like the one above to that code engine enables accessing the virtual file system structure with the data about the virtual path that has to be followed for accessing the encoded document:
Start at e.g. drive D: as starting point for the virtual drive or e.g. D:\GFVFS for the virtual file system or file system structure respectively.
Cut code before the first segment with segment type x, e.g. ST5.0. Segment type x is configurable.
Mirror each segment of segment type x (here ST5.0) to a folder in the given order.
Stop before the segment with a segment type x.i etc for i=1, 2, . . . etc (here ST5.1). Segment type x.i is also configurable.
Access the file with name:=value of code segments with segment type x.i etc for i=1, 2, . . . etc (here ST5.1

What kind of access the user gets to the document, here doc1.docx, depends on his authorization. Before the code engine starts to mirror the code into a virtual access path to the encoded document, it checks the identification and authentication of the user, derives his authorization, and evaluates if the code is a valid code in the scope of the given application and environment.

These data are also used, e.g. during login of a user, to built up the virtual file system structure according to the user's authorization and the security policy.

Characteristics of a Code Template that Enables the Mapping to a Virtual Storage Structure

The following example supposes
that code templates are defined following a logical data structure e.g. within the said code engine and stored within a storage device such as a database according to the logical data structure;
that the segments of such a code template got meaningful values for all the segments beside that ones that define the unique individual values per sample.
that the segments that define the unique individual values per sample are also recognizable at code template level, e.g. via their segment type and additional data of this type;
that only such segments are mapped to the virtual file system structure that are of particular segment types. The selection of those segment types is preferable configurable;
that a sample is represented by at least one named file. The file name is unique in the scope of the other segment values of its code in the given order; and
that an encoded sample is shown as file in a folder that is a mapping of the last segment before the (first) individual and unique sample identifying segment.

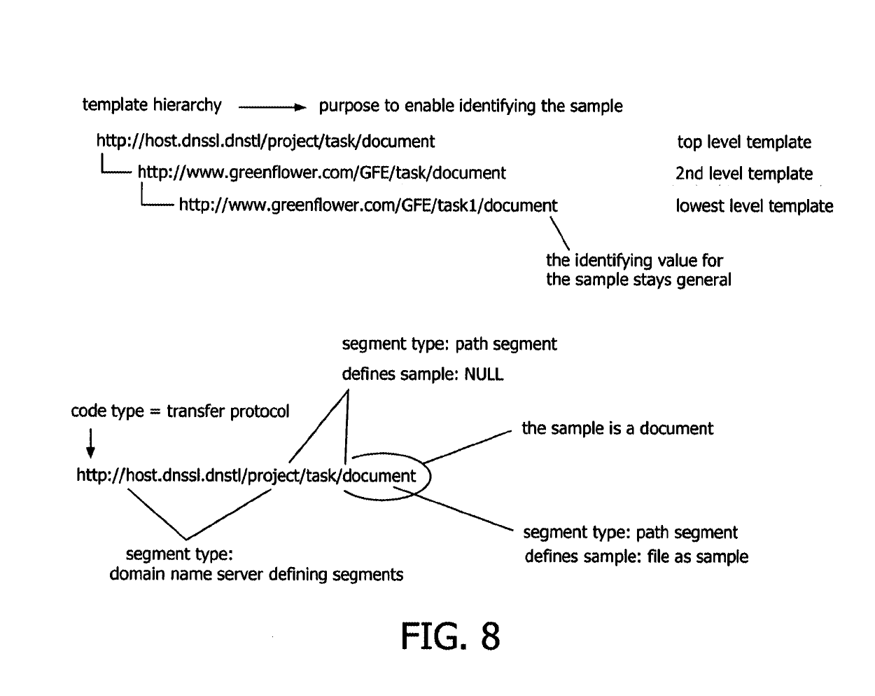

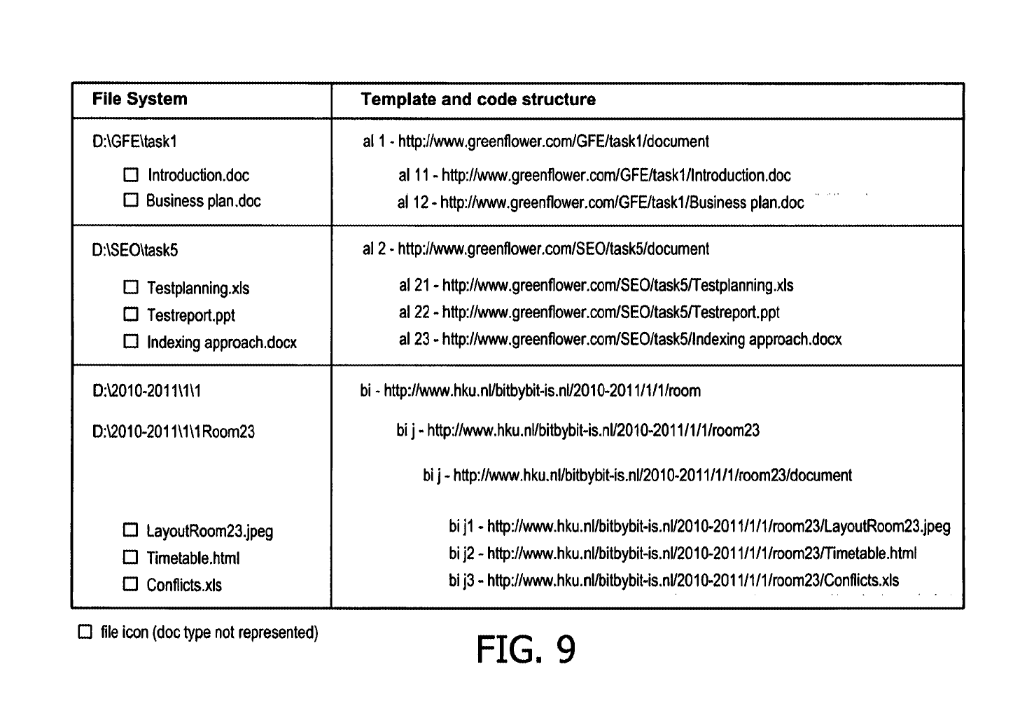

FIG. 8 shows how an example code template, interpreted in a way that will lead to the mapping to virtual directories and files. FIG. 9 shows the result of the mapping from a code template to a virtual file system structure in the left column of the table. In the right column, it is shown what the original code templates and codes are that led to the mapping result. The letter-cipher combination at the beginning of the templates and codes in FIG. 9 are introduced here for simple referencing from the text of this document. In FIG. 9, templates starting with hint “a” define a sample that is a document; the template starting with hint “b” defines a sample that is not a document but a room. Within the scope of the code engine according to the invention, any sample can be represented within the digital storage device only by means of files, such as document files. However, those documents considered under template “b” are not samples in the same sense than those defined starting here with the hint “a”. They are describing another sample (the room), only.

### Documents and Files as Samples

If a document is the sample, the template contains a segment specifying the document; this is by default of a particular segment type, let's say “ST5.1”. During encoding, the segment “document” of example templates “a11” and “a12” is filled in by the document's name (inclusive the .extension). See in FIG. 5 the codes a111, a112, a121, a122, and a123. See first and second part of the right table column FIG. 5. As shown in FIG. 8, the document codes consist of the segment values of the code template lowest in the template hierarchy plus the value of the segment of a particular segment type, here ST5.1. Each code gets the document name filled in into this segment during encoding.

Samples Different from a Document

If the sample is different from a document, the template contains no segment for the document in the first place. All documents are considered to be just specifying data on the sample (not the sample itself!); for example in FIG. 5 under “bij” where Room23 is the sample; the value “Room23” is the individual unique identifier for the sample according to the template segment “room”; this is example code template http://host.dsnsl.dnstl/intermediate/studyYear/period/week/room.

During encoding, the segment “room” is filled in by the rooms' names as shown in FIG. 5 at hint “bij”, here with “Room23”. However, it seems practical to have a code for each separate document even if it is not a sample in the first place but describes another sample. This is enabled by considering such documents as samples within the scope of the sample room Room23, here; and, that means to extent a non-document template with a segment for “document” automatically. However, related to the first sample=the scope for the individual definition of the originally specifying documents. Being able to do so, the extended template can only be defined after the non-document sample is encoded; this, to know the sample's identifying value in segment “room” as e.g. “Room23”.

### Elaboration of the Principle of Mapping a Database Table Structure to a Virtual Storage Structure

The principle of mapping as introduced via the aforementioned examples can be elaborated in several ways. The aforementioned code template and code structure is just an application using conceptual or logical data structures e.g. of a database, adding an interpretation to the structure (e.g. the code templates) and mapping that interpreted conceptual or logical structure at least partly to a virtual storage structure. If once established, the folder structure can be mapped back to the conceptual or logical data structure (on user interface side via the interpretation logic), e.g. to data within the database that realizes the conceptual or logical data structure and being interpreted according to the interpretation logic. The logical data structure can also be mapped to be visualized as string representation in such a way that the string is shown as extended name of a virtual folder and file presentation. Always, the presentation shows in fact the template in case of a virtual folder visualization and the code in case of a virtual file presentation. Nevertheless, the user interface presents an icon of a folder or a file and handles the icon as if it would be the folder or file.

One of the elaboration options is to offer a virtual file/folder system structure that represents in fact a well designed code template structure according to the administration, structural, archiving etc requirements of an institution or person (represented by the code template owner segments via its IP-addresses or domain names respectively) to an end-user and map this code template structure into a virtual file/folder system structure which may be a multi-user dashboard, for example as shown in FIGS. 15-18. The end-user may place files into a directory of this structure; at the first place into the lowest level directory. He could do this by saving a new document or an opened document into such a directory. It is allowed to overwrite an existing file in such a directory. He could modify the name and select another type for the file. He could save the file as a shortcut or symbolic link into such a folder. He could also use copy and paste as well as cut and paste functionality etc. All those functionality and behavior of the functions, the directories, and files are mostly the same as known by default in a folder/file system and/or in office applications and/or document management systems.

Saving a file, e.g. a document, into a virtual folder of the virtual file system structure triggers encoding the file. Thus, the file hasn't to be known before the mapping of the template to the virtual folder. Just by placing a document into a virtual folder according to the invention, the folder system can be used to enable encoding in a most simple way without any special knowledge of the end-user.

The encoding functionality of the code engine uses the code template that is mapped by the branch of the particular folder where the file is saved into plus the file's individual identification value, e.g. the documents name plus extension.

During encoding, a code string is created. This code string can be used to distribute the file, e.g. by sending it via email to intended receivers. Applying that code to a browser will lead to the virtual location of the file as aforementioned and enable file sharing. The end-user does not necessarily deal with the encoding engine to get access to the code string. The code string could be sent automatically with an email or sms or comparable distribution means to an the end-user triggered by the encoding function to enable further distribution; it could also be inserted into e.g. the Office suite metadata of the encoded file and from there used by the end-user for distribution of the file just by sending the code using a e.g. email functionality from out the code engine in the background of the virtual file/folder system structure; a shortcut or symbolic link with the code contained in the file's metadata could also be created automatically by the code engine and placed into a folder where the encoded file is intended to be saved into as a duplication; etc. The shortcut or symbolic link can be used to distribute the document to users which have no access to the virtual storage at first hand, also as already aforementioned. Also as already mentioned, sharing of files between user who have access to virtual folders of the invention is happening by giving access to the virtual file itself or to the virtual folder where the file is virtually saved (virtual folder path equals the code string of that file).

Deleting a file is logical delete; the created codes will still “work”. Renaming is organized in a way that existing codes can find the intended file even if he got another name. In all such cases as discussed, it is supposed that the end-user is forbidden to modify the official file system structures that are shared by a configured set of users. Modification of the shared virtual file/folder system structure is here allowed for competent administrators. Another case is that the end-user is allowed to modify at least a part of the virtual file system structure. Due to the relationship between code template structure and virtual file system structure, a modification of the file system structure has to trigger modification of the code template structure. This is enabled for all personal parts of a virtual storage structure or private implementations of the method and system according to this invention as well as for end-users with rights to establish virtual folder structures according to their responsibilities in the client institution.

FIG. 6 illustrates where modifications in the file system structure have impact on the code template structure and via the code template structure on the codes for relevant files. FIG. 6 shows in the upper part the impact of a folder extension onto the code template definition and encoding of documents that are placed into a virtual folder branch that got an extension by placing an additional virtual folder; in the example extent branch “MyDocuments\Temp” with folder “Photos” to get the branch “MyDocuments\Temp\Photos”. The code engine has to extent the code template by an additional segment, called “Photo” with a configured segment type. Moreover, the code engine has to re-code all documents by using the new template. However, internally it will copy the former code template; mark it as deleted, and extent the copy with the new segment. Also the old codes will be marked as deleted. Nevertheless, if such an old code was distributed already and will be still applied to get access to the photo “Photo1.jpeg” in this case, the photo can be found. Because the old code is marked as deleted, it can't be distributed anymore if a constraint is realized that only non-deleted codes are offered for distribution. FIG. 6 shows in its bottom part the impact of deleting a folder onto the code template definition and the encoding of documents. In the case of deleting a folder that is not the leaf in a branch, the documents keep their placement in the file system structure. In case that a leaf folder is deleted, the documents have to be moved automatically to the now leaf folder or the user has to be asked if he wants to delete all documents placed into this folder.

The internal processing modifies the code template structure and re-encoding of files without interference by the end-user or an administrator. The internal processing organizes also that older codes, created before a part of the file system structure is modified, can be applied also in the future.

### Encoding a Shortcut or a Symbolic Link Instead of a Document or Creating a Shortcut or Symbolic Link of an Encoded Document.

Shortcuts can be used in MS Windows to refer to a target file. This target file is represented by the shortcut. Shortcuts work only within a graphical user interface system. In Unix desktop environments, this functionality can be taken over by .desktop files or even by the more advanced symbolic links. In Apple Macintosh environments, aliases fulfill a similar function. Related to the invention, such means as shortcuts can be used to represent an encoded file and being distributed with the code enclosed. In this case, the already existing functionality of a shortcut, a symbolic link, a desktop file, or an alias will be applied to carry the code and enable access to the encoded file. A user can create e.g. a shortcut of a code file and send this shortcut to other persons e.g. by email. The receiving user can place this shortcut instead of the referenced file within his virtual file system structure; this is a kind of duplication the file virtually. The first code is placed according to the meaning giver by its e.g. creator by saving the file into a particular virtual folder. Another user, copying a shortcut of the virtual file (thus, in fact a shortcut of the code of the file) into another virtual folder, encodes the shortcut with the template definition of the actual virtual folder. The original file is encoded with the first code; the second encoding (the encoding of the code) is registered internal in the code engines database. With other words, the shortcut will be handled as the document and encoded according to the code template where the receiving user placed the shortcut. The user can give the short-cut file his own name to fit into his template's semantics. However, the original file is still not duplicated. As soon as the user activates the shortcut, the original file is accessed via the code carried within the shortcut. A shortcut or a similar concept such as a symbolic link can be also used within a shared virtual file system structure and an additional personal virtual file/folder system structure to code an already existing and encoded file with another user's semantics, for whatever reason, and still keep the original file untouched an unduplicated. The shortcut, symbolic link, or alias etc will be considered as a file by the code engine and encoded as a file in those cases.

### Placing a File in a Non-Leaf Virtual Folder According to the Invention

As discussed in a previous part of this description, documents could be placed in principle also in virtual directories that are not leafs. If this is the case, those documents are interpreted to be shared by all branches with the folder of placement as root or for all templates which share the segments that corresponds to the folder of placement.

### Example:

Suppose the following templates:

The parent template:

T1: www.greenflower.com/GFE/task/document

and its children

T 1.1: www.greenflower.com/GFE/task1/document

T 1.2: www.greenflower.com/GFE/task2/document

T 1.3: www.greenflower.com/GFE/task3/document

with a virtual file/folder system structure on virtual drive D:

| | |
|---|---|
| D:\GFE\task1 | is equivalent to T1.1 |
| D:\GFE\task2 | is equivalent to T1.2 |
| D:\GFE\tasks | is equivalent to T1.3 |

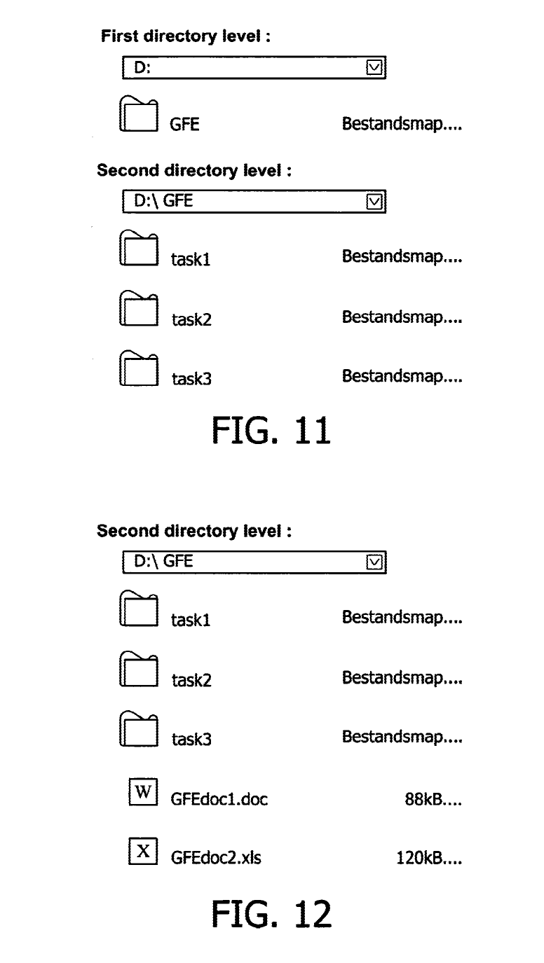

looking like the visualization shown in FIG. 11.

Suppose GFEdoc1.doc and GFE.doc2.xls are documents which belong to the project GFE and not to only one task. Logically, they will be placed into virtual folder GFE and not in one of the directories tasks1, task2, or task3.

FIG. 12 shows an example of placed documents into a virtual folder that is not a leaf-folder. As soon as this is done, a template T 1.1 has to be created automatically, looking like www.greenflower.com/GFE/task1/document

and the two documents have to be encoded as follows:
www.greenflower.com/GFE/task1/GFEdoc1.doc and
www.greenflower.com/GFE/task1/GFEdoc2.xls.

If one of those codes is distributed, the authorized receiver can access GFEdoc1 or GFEdoc2, dependent which code he received. The access- and authorization strategy of the owner institution may allow that the user gets also access to the other documents in the same folder, here GFE, and additional to all the documents which are encoded in the branches from GFE, here the documents in virtual directories task1, task2, and task3.

Suppose, a document GFEdoc3.docx is placed in virtual folder task3 and encoded following code template T1.3 as www.greenflower.com/GFE/task3/GFEdoc3.docx. This code is also distributed to authorized users. If a user applies this code to access GFEdoc3.docx, he may get access not only to this document and its versions, however also to all the other documents in virtual folder task3 and, additionally to the documents encoded in the parent directories, here in GFE. This depends on the access- and authorization strategy of the owner institution.

### Additional Code Engine Internal Processing

The data store related to the code engine may contain a (cross reference) table that maps the code of a document direct to its physical storage location. In an embodiment of the invention, this table enables organizing versioning on a logical structural level. A new encoded document starts a new version tree in this cross reference table. Saving an encoded document without changing its name after any write operation creates a new version of the document (child of its top entry). The Foreign Key (FK) to its parent entry has to be inserted into the record of the version.

Changing the document type starts also a new version tree if the data about the original version are “lost” during the “Save as” action for the document.

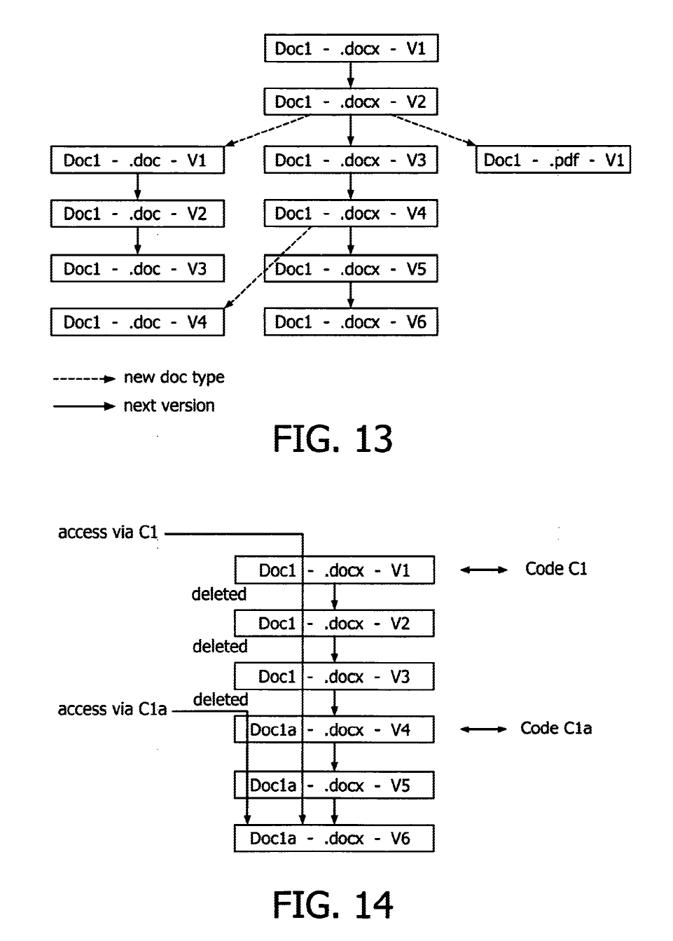

FIG. 13 shows the version trees of a document Doc1 with different document types. The solid line arrow points to the next version. In a more sophisticated embodiment of the invention, the connection between the new document type version and the original one will be kept e.g. via stack data or the triggered transaction as possible options.

Changing the name of a document without copying it or without changing its location in the virtual file system structure respectively, means the original has to get a new code, however doesn't start a new version tree on its own. It just continues as the next version in the branch of its document type. The table records before the record with the new name are marked as deleted. Their code stays untouched. If someone uses this code, the document can be found the usual way.

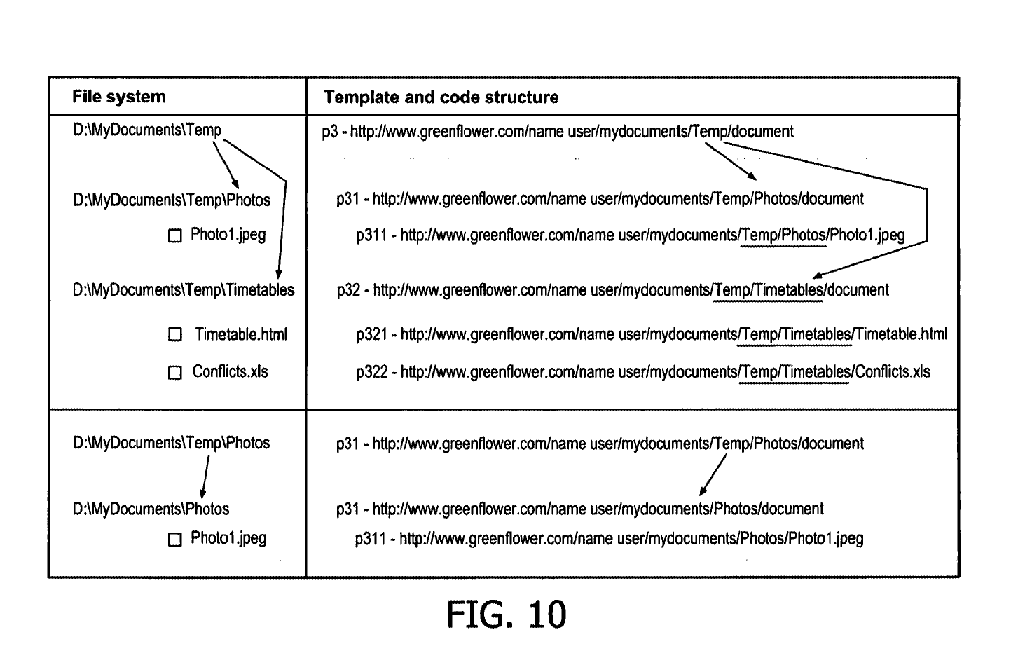

The following FIG. 10 shows a part of the above introduced version tree. The name of the document is changed in version 4 from “Doc1” to “Doc1a”. Versions 1, 2, and 3 of “Doc1” are marked as deleted within the particular table. They related to code “C1” (the original code for this document); inserting the new name triggers re-encoding of the document. The new code “C1a” is referred to from the record for version 4. If a user submits code “C1”, the version tree is accessed starting from version 1 and continuing to the most actual version in the tree; if a user submits code “C1a”, the version tree is accessed starting at version 4 and continuing to the most actual version in the tree. In both cases, the whole version tree will be shown for selection if a user selects the function for showing the whole version tree.

FIG. 14 shows a version tree of a document Doc1 in case the document name changed but the placement of the document in its folder as well as the document type did not change. The user does not see anything from the versioning during any save action. If a user opens a document in an embodiment of the invention, he sees the most actual version of the document by default. He is enabled to open the version tree of this document, e.g. by pressing the right mouse button, and selecting “Show versions”. He can unfold the tree or branches respectively. If he wants to open a particular version of a document, he clicks the entry within the version tree.

The following list illustrates an embodiment of functions of a user interface applied in the method according to the invention. The below functions may be applied in combination or independently from each other.

### Users

Identify users (including roles/profession)
Authorize users (and stand ins)
   Show users (and stand ins)
   Add and remove users (and stand ins)
   Update personal and user data inclusive email and other transmission addresses for code distribution
   Select user or stand in (show related data including the user groups of the user)
   Alert users of the project and their roles
   Report user activities including sending activity streams to the user's visualization of concerned files and folders;
   Activate user interface related to devices (office, web and mobile)

### Contacts

Show contacts (external)
Add and remove contacts (includes names and e.g. email addresses)

### User Groups

Add and remove user groups
Add and remove responsibilities to user groups (expressed as code and code template independent authorizations like the right to add, delete, rename virtual folders in general)
Relate user groups and/or build subgroups and categorize the relationships according to the mutual dependencies with respect to the roles to gain specified expected results of a task e.g. in a project phase
Select user group (show related data including related virtual file structures and group members)
Relate and remove users to/from user groups; e.g. enabled by drag and drop

### Code Templates as Well as Virtual Folders and Files

Show encoded files within the virtual folder structure; open en close folders
Select an encoded file (includes showing metadata and showing the file's code as string)
Encode a file (is here equivalent to save a file in a virtual folder)
Open an encoded file
Copy and paste an encoded file (includes: encode the copy)
Cut and paste an encoded file (includes: re-encode)
Rename an encoded file (includes: re-encode)
Delete an encoded file (is a logical delete, the deleted version of the file can still be available for submitted codes of the deleted file version; then, marked as deleted; otherwise the submitting user is just informed that the file is deleted)
Create a shortcut and move the shortcut (cut and paste the shortcut, includes encoding the shortcut)
Add a folder and remove a folder (includes: re-encoding all files of the branch); means update a code template, in fact
Rename a folder (includes: re-encoding all files of the branch); means update a code template, in fact
Management: Derive, test approve and authorize a suitable code template for encoding a not encoded file based on the content of the file or the derived meaning of the file from some configurable structural parts of a file; the derivation can include selecting an existing code template as suitable for encoding the file or generate an additional code template based on the as new recognized semantics of the file.
Report track and trace and management information of the community and encoded files; uses the logging data from the code engine database; is activated for function selection when the encoded file is selected; see the functionality list Reporting and tracking and tracing. The mentioned report here is dedicated to a particular file, always. The report can be activated e.g. direct from the file's dedicated activity/function list.
Management: Initiate, design, test, approve, maintain and administer code templates.
Users and User groups
Relate and remove users to/from user groups; e.g. enabled by drag and drop

### Users and Encoded Files

Grant and remove access to a file e.g. drag and drop an image of the user name to the file icon or vice versa;
Handle the file according to the permissions;
Send an encoded file by email (includes: authorization); is in fact, send the code (starts from the selected file);
Communicate about a file with users (send messages about the content, express like it, follow it, etc).

### Contacts and Encoded Files

Send and receive an encoded file by email is in fact, send the code (start from the selected file);
Handle the file according to the permissions;
Communicate about a file with users of the application (send messages about the content, express like it, follow it, etc).

### Users and Virtual Folders;

Grant and remove access to a virtual folder (a branch of the virtual folder structure) (e.g. drag and drop a virtual image the user name to the leaf virtual folder icon of the branch or vice versa)
Handle the folder and the files in the folder according to the permissions;
Communicate about the folder and the files in the folder with users (send messages about the content, express like it, follow it, etc).

### User Groups and Encoded Files

Grant and remove access to a file (includes: authorization) (e.g. drag and drop a virtual image the user group name to the file icon or vice versa)
Handle the files according to th epermissions;
Communicate about a file with other users of the group (send messages about the content, express like it, follow it, etc).

### User Groups and Virtual Folders

Grant and remove access to all files in a branch of the virtual folder structure (includes: authorization) (e.g. drag and drop a virtual image the user group name to the leaf virtual folder icon of the branch or vice versa)
Handle the folder and the files in the folder according to the permissions;
Communicate about the folder and the files in the folder with users (send messages about the content, express like it, follow it, etc).

### Reporting Management Information and Tracking and Tracing

Generate overviews on user rights and responsibilities and behavior patterns with respect to a particular file of a set files, e.g. encoded applying a particular code template.
Generate overviews on selectable actions on a particular file or a set of files following selected filter criteria; structure and content of the elements of the overview are selectable.
Generate tracking and tracing overviews, e.g. of actions of particular users or actions on a particular file during a specified period.
Generate reports concerning importance of files for e.g. a particular user, for user groups, related to a particular task or subject etc.
Derive a proposal for value estimation of particular data, files, subjects etc with respect to e.g. actors or receivers; propose a context of interest e.g. per user on his User interface.
Generate reports concerning the importance of particular user groups for a particular user e.g. based on the frequency of being a part of the group of sharing files with each other. The reports can include finding patterns of preferred community building with respect to particular projects and/or tasks. Furthermore, the reports can include preferred handled files, and building a connection to the preceding mentioned proposal.

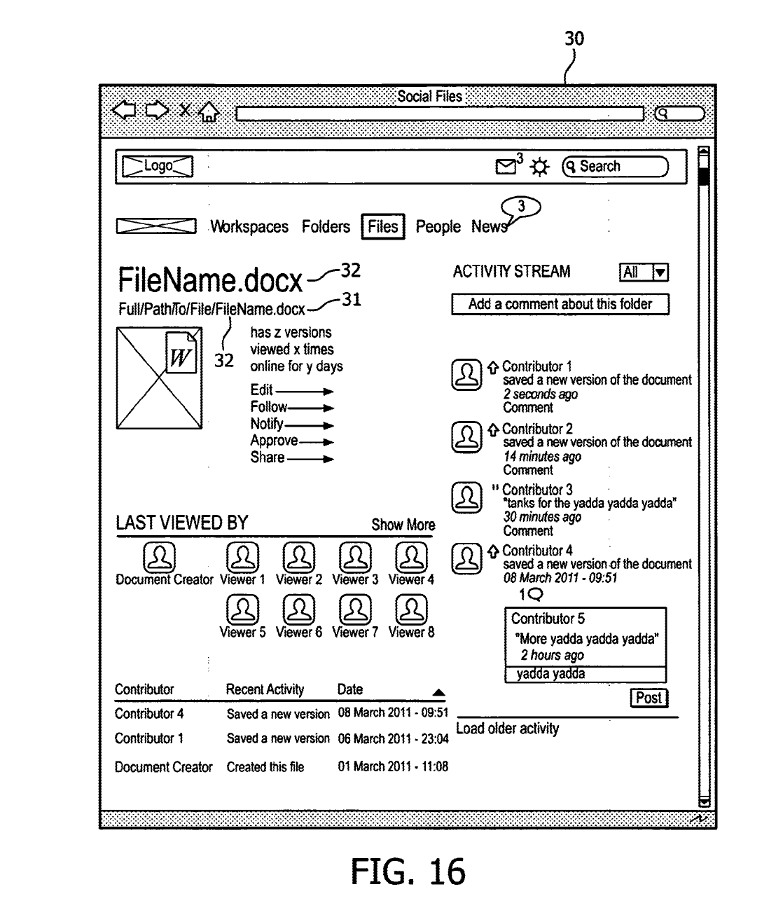

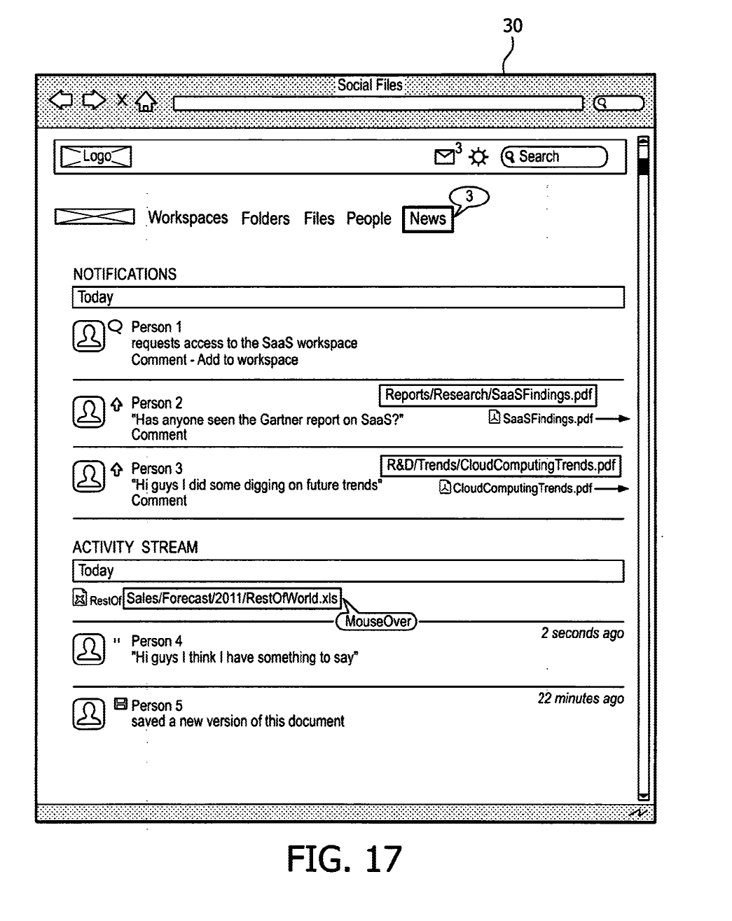

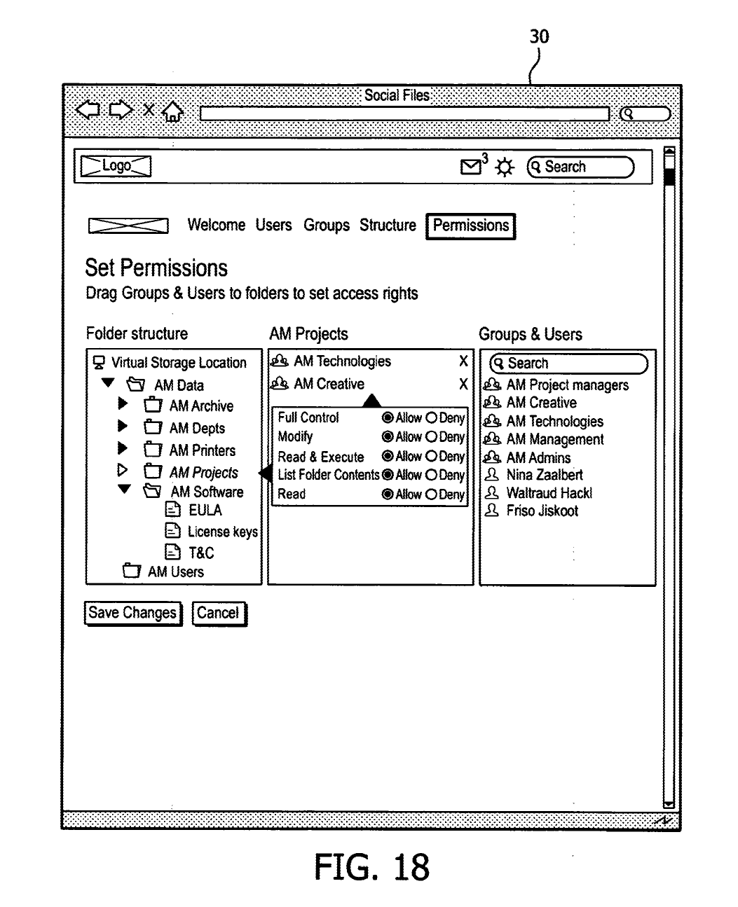

FIGS. 15-18 show views of an exemplary web based multi-user dashboard 30 (workspace environment), wherein use is made of sample codes according to the invention. In FIG. 15 a virtual digital path 31 is shown for virtual storage of digital samples, the (full) digital path together with the sample name 32 of a digital sample forms the sample code of said sample. In FIG. 15 it is further indicated that in the specified folder 31 digital samples are virtually stored and that 8 users do have (restricted) access to this particular dashboard 30. Furthermore, various other statistics 33 and an user related activity stream 34 is visualised in order to keep track of all changes/comments made relating to the digital sample(s). All files shown on that dashboard are virtual and encoded with the virtual folder path that “leads” to the visualized folder dashboard. All functions, actions, and data shown on this dashboard are in fact related to the virtual folder and the virtual files shown there, The screen of the dashboard 30 as shown in FIG. 16 shows details of a digital sample, such as the full virtual path 31 (here representing the sample code) and the file name 32 (representing a code segment of the sample code). The dashboard 30 appears to offer a file to users (members), but in fact merely the sample code is offered and handled; all presented actions, functions, and data are related to the sample code, in fact. Further sample related information, such as the number of versions, the frequency of viewing the sample, and the age of the sample (publication date of the sample code on the dashboard) are also shown on this screen. FIG. 17 shows a messaging user interface of the dashboard 30 where all messages are shown in the context of the digital sample files, in fact related to the sample codes. These messages may e.g. have news value and/or social value. FIG. 18 shows an admin user control panel of the dashboard 30 where the relationships between the code templates and codes on one side, and user groups and individual user on the other side can be defined. Included in the definition of the relationships between templates/codes and user groups/users is granting a permission. It defines e.g. if the related users may read or write files encoded with the related codes etc. It should be clear that the visualization of the templates and codes support the impression of a virtual folder structure with included files, again. In the visualization, the sample codes and code templates are presented as virtual folders and files and in fact the one original stored file is handled; For the user the handled code seems to be the file. It is imaginable to encode the dashboard as such as well is encoded in accordance with the present invention, wherein a dashboard identification in fact forms a code segment making part of the dashboard sample code as such.

It should be noted that the above-mentioned embodiments illustrate rather than limit the invention, and that those skilled in the art will be able to design many alternative embodiments without departing from the scope of the appended claims. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be advantageously used.

1. A method for compiling a unique sample code for a digital sample, comprising:
A) defining at least one sample code template comprising multiple sample code segments to be used for building a sample code for a digital sample, said sample code segments at least comprising:
a sample owner identifying code segment, and
a sample identifying code segment,
B) specifying the content of at least one sample code segment to be used for building at least one sample code, wherein the sample owner identifying code segment is specified by an Internet address, in particular an IP address and/or a domain name, of an owner of the digital sample,
C) visualizing at least one specified code segment as a virtual storage folder in a user interface,
D) specifying the sample identifying code segment by creating a digital sample name of a digital sample in a selected virtual storage folder,
E) stringing the specified sample code segments to form the sample code,
F) defining a digital path to a storage location via which access can be gained to the digital sample, and
G) creating a cross-reference between the sample code generated during step E) and the digital path defined during step F) in case the sample code and the digital path are mutually distinctive.

2. The method according to claim 1, wherein during step C) the name of virtual storage folder is related to the content of the specified code segment.

3. The method according to claim 1, wherein multiple code segments are specified during step B), and wherein each specified code segment is shown as separate folder in a folder structure during step C).

4. The method according to claim 3, wherein different code segments are specified during step B), and wherein each specified code segment is shown as separate folder in a folder tree structure during step C).

5. The method according to claim 1, wherein during step C) or D) a user may create and specify at least one virtual folder related to a code segment to be stringed during step E).

6. The method according to claim 1, wherein during step C) at least one specified code segment, in particular the sample owner identifying code segment, is not visualised in the user interface.

7. The method according to claim 1, wherein the digital path represents a Uniform Resource Locator (URL).

8. The method according to claim 1, wherein the digital path refers to a digital location, in particular a web location, where the digital sample is stored.

9. The method according to claim 1, wherein the method comprises step H) comprising storing the sample code, the digital path, and the cross-reference between the sample code and the digital path in a database.

10. The method according to claim 1, wherein at least a part of the digital path and the sample code are identical.

11. The method according to claim 10, wherein the digital path and the sample code are at least substantially identical.

12. The method according to claim 9, wherein the method comprises step I) comprising converting the sample code formed in step E) into a machine-readable format.

13. The method according to claim 12, wherein the method comprises step J) comprising translating at least the sample identifying code segment of the sample code into another language and character set.

14. The method according to claim 1, wherein during step D) the sample identifying code segment is specified by identifiable metadata relating to the digital sample.

15. The method according to claim 1, wherein the sample code segments defined during step A) further comprises a user related code segment.

16. The method according to claim 1, wherein the sample code segments defined during step A) further comprises an intermediary code segment.

17. The method according to claim 1, wherein the sample code segments defined during step A) further comprises a checking code segment representing the result of a predetermined mathematical processing of at least one other sample code segment.

18. The method according to claim 1, wherein the sample code segments defined during step A) further comprises a sample code security identifying code segment.

19. The method according to claim 1, wherein during step A) at least one punctuation mark is defined for separating adjacent code segments during step E).

20. The method according to claim 1, wherein during step A) an order of defined code segments to be stringed is defined.

21. The method according to claim 13, wherein step A) is processed repeatedly to generate multiple sample code templates, wherein the method further comprises step K) comprising choosing a code template to be applied prior to executing step B).

22. The method according to claim 1, wherein during step B) at least one code segment is specified several times to form multiple sample codes, wherein said specified code segments are visualised as virtual folders during step C).

23. The method according to claim 1, wherein at least one virtual storage folder and/or the digital sample name is modifiable by at least one user.

24. The method according to claim 1, wherein an in a virtual storage folder virtually stored digital sample is visible to multiple users.

25. The method according to claim 1, wherein the virtual storage folder makes part of a web based graphical dashboard.

26. The method according to claim 25, wherein said graphical dashboard is accessible after authentication of a user.

27. The method according to claim 1, wherein user based activities related to the digital sample are logged.

28. The method according to claim 27, wherein at least a part of the logged user based activities is published on the graphical dashboard.

29. The method according to claim 1, wherein digital sample related statistics are logged.

30. The method according to claim 29, wherein at least a part of the logged statistics is published on the graphical dashboard.

31. The method according to claim 25, wherein the graphical dashboard is provided with a unique sample code.

32. The method according to claim 1, wherein during step C) at least one specified code segment is represented in an iconographical format.

33. The method for providing a digital sample with a unique sample code of claim 21, further comprising:
L) creating a digital sample,
M) compiling a unique sample code for the digital sample,
N) marking the digital sample with at least one compiled sample code,
O) storing the digital sample at a digital location,
P) storing the sample code, and
Q) creating a cross-reference between a digital path referring to said digital location and the sample code in case the sample code and the digital path are mutually distinctive.

34. A computer-readable medium with computer-executable instructions which, when loaded onto a computer system, provide the computer system with the functionality of the method as claimed in claim 1.

35. A sample code as compiled by the method according to claim 1.

36. A database comprising at least one cross-reference between a sample code according to claim 35 and a digital path to a digital location where a digital sample associated with said sample code is stored.

37. A database comprising a cross-reference between virtual file system structure and a logical file system structure for use in the method according to claim 1.

38. A system for compiling a unique sample code, comprising:
at least one sample code template generator for defining at least one sample code template comprising multiple sample code segments to be used for building a sample code for a digital sample, said sample code segments at least comprising a sample owner identifying code segment, and a sample identifying code segment,
at least one sample code segment specification module connected to said template generator for specifying the content of at least one sample code segment defined by means of the code template generator, wherein the sample owner identifying code segment is specified by an Internet address, in particular an IP address and/or a domain name, of an owner of the digital sample,
at least one visualization module connected to said specification module for visualizing at least one specified code segment as virtual storage folder in an interactive user interface,
at least one data entry module connected to said visualization module allowing the user to specify at least the sample identifying code segment by creating a digital sample name of a digital sample in a selected virtual storage folder,
at least one code generator connected to said template generator and said specification module for stringing the specified sample code segments to form the sample code, and
at least one database for storing at least one cross-reference between a generated sample code and a digital path to a digital location via which access can be gained to the digital sample in case the sample code and the digital path are mutually distinctive.

39. The system according to claim 38, wherein the system further comprises a sample storage device for storage of a digital sample at a digital location of which the digital path is stored in the database.

40. The system according to claim 38, wherein the system further comprises a communication module for communicating the generated sample code to a user.
